(19) United States
(12) Patent Application Publication
(10) Pub. No.: US 2026/0087426 A1
(43) Pub. Date: Mar. 26, 2026

(54) CROSS-ENTITY OPERATION ANALYSIS AND PRESENTATION COMPUTING SYSTEM

(71) Applicant: Dimensional Insight, Incorporated, Burlington, MA (US)

(72) Inventors: Frederick A. Powers, Sudbury, MA (US); Zhenggang Hu, Waltham, MA (US); James Clark, Andover, MA (US)

(21) Appl. No.: 19/335,320

(22) Filed: Sep. 22, 2025

Related U.S. Application Data
(60) Provisional application No. 63/697,915, filed on Sep. 23, 2024.

(51) Int. Cl. G06Q 10/0631; G06Q 10/0633; G06Q 10/105

(52) U.S. Cl. CPC G06Q 10/0631; G06Q 10/0633; G06Q 10/105

(57) ABSTRACT

Techniques are provided for adaptively presenting business measures within an organization. Employee roles are categorized within a learned organizational hierarchy, and workflows are analyzed to identify associations with the role categories. Usage of business measures is evaluated to determine their relevance to portions of the hierarchy. Based on these learned associations and relevance, domains of measures are generated and reconfigured in response to feedback from observed user interactions. Visualization modules are assigned to the measures by mapping them to display groups and unique page identifiers within a modular display framework. Domain-specific dashboards are then rendered on an electronic display to deliver tailored and dynamically updated presentations of business measures aligned with organizational context.

### CROSS-REFERENCE TO RELATED APPLICATIONS

This application (DMSL-0008-U01) claims the benefit of U.S. Provisional Patent Application No. 63/697,915 (DMSL-0008-P01) filed Sep. 23, 2024, the entirety of which is incorporated herein by reference for all purposes.

### BACKGROUND

Business entities generate a plethora of measures/KPIs for a wide range of business activities. Different portions of a business entity, such as different functional groups, levels in an organizational hierarchy, and the like tend to focus attention of subsets of measures that may, for example pertain more particularly to relevant business operations goals and the like of the portion of the business entity. Business systems that provide access to subsets of measures generally are unwieldy, requiring continuous manual adjustment of definitions of measures, customized collections of measures, and the like. There is a need for a cross-business information analysis and presentation platform that uses intelligence-enabled computing systems to provide dynamic targeted presentation of measures efficiently and based on context of the underlying business goals, priorities, user preferences, and the like.

### SUMMARY

In aspects of the methods and systems described herein, a computing system platform may have a data collection and analysis module for generating measures of activities described in a set of workflows of a business entity. The computing system platform may have a user interface accessible through an electronic display of a computing resource of the platform, the user interface adaptably representing sets of measures responsive to one of a group selection or a domain selection and to selection of one or more of a plurality of dynamic measure display filters in the user interface. The computing system platform may have an adaptive intelligence module that may learn an organizational structure of the business entity including categories of employee roles. The adaptive intelligence module may learn relationships between the workflows and portions of the organization structure, and relevance of generated measures to portions of the organizational structure based on use of the generated measures by a plurality of the categories of employee roles. The adaptive intelligence module may further generate at least one of: sets of measures as a group of similar measures based on at least one of a degree of similarity of data contributing to each measure or a dimension of the contributing data that is common across a plurality of types of the contributing data, or sets of measures as domains that are based on the learned relationships, learned relevance, and learned organizational structure. The learnings of the adaptive intelligence module may be adjusted through relearning based on feedback developed from observing user interaction with the platform through the user interface.

In aspects of the methods and systems described herein, a platform for assisting in structuring a plurality of measures into overlapping subsets targeting operational portions of a business entity may have an organizational structure learning module that learns an organizational structure of the business entity including categories of employee roles. The platform may have a workflow relationship learning module that learns relationships between the workflows and portions of the organization structure. The platform may have a measure relevance learning module that learns relevance of generated measures to portions of the organizational structure based on use of the generated measures by a plurality of the categories of employee roles. The platform may generate candidate groups of sets of the measures based on at least one of a degree of similarity of data contributing to each measure or a dimension of the contributing data that is common across a plurality of types of the contributing data. The platform may generate candidate domains of sets of the measures based on the learned relationships, learned relevance, and learned organizational structure. The platform may have a feedback development module that forms feedback for the platform by analyzing observed user interaction with the platform through the user interface and that retrains at least one of the organizational structure learning module, the workflow relationship learning module, or the measure relevance learning module based on the feedback formed from the analyzed user interactions.

In aspects of the methods and systems described herein, a platform for determining relationships among measures of business activities described in workflows of a business entity and portions of an organizational structure of the business entity may have an organizational structure learning module that learns an organizational structure of the business entity including categories of employee roles. The platform for determining relationships among measures of business activities may have a workflow relationship learning module that learns relationships between the workflows and portions of the organization structure. The platform for determining relationships among measures of business activities may have a measure relevance learning module that learns relevance of generated measures to portions of the organizational structure based on use of the generated measures by a plurality of the categories of employee roles. The platform for determining relationships among measures of business activities may identify use of measures by a plurality of portions of the organizational structure based on observing access to the measures by employees associated with each of the plurality of portions of the organizational structure. The platform for determining relationships among measures of business activities may weight the use of the measures based on a category of a role of each employee accessing each of the measures. The platform for determining relationships among measures of business activities may calculate a degree of measure usage by each of the plurality of portions of the organizational structure for each measure by computing the observed access with the weighting. The platform for determining relationships among measures of business activities may have a domain-set recommendation module that determines a degree of usage measure threshold for at least one of the plurality of portions of the organizational structure, above which corresponding measures are identified as candidate measures for inclusion in a domain measure-set, wherein the domain measure-set is accessible to a portion of the employees of the at least one of the plurality of portions of the organizational structure in a domain-specific dynamically rendered dashboard in an electronic user interface, and wherein a user (expert) finalized the domain measure-set by selecting a fixed set of measures among the candidate measures, a fixed set of filters for the domain measure-set and at least one user-selectable dynamic filter.

In aspects of the methods and systems described herein, a platform for relating a dimension value to a set of business performance measures may have a set of dimensions that characterize business data entries used to calculated business performance measures, wherein each data entry characterized by a dimension represents a value of the dimension (a “dimension value”). The platform for relating a dimension value to a set of business performance measures may have a dimension selection facility that receives a business data entry and produces one or more dimension identifiers based on the set of dimensions. The platform for relating a dimension value to a set of business performance measures may have a primary dimension determination facility that determines a primary dimension for the business data entry based on utilization of the business data entry as a dimension value for the primary dimension. The platform for relating a dimension value to a set of business performance measures may have a KPI detection facility that determines one or more KPIs that are impacted by the primary dimension, based on a [description of] [business rule for] calculating the one or more KPIs. The platform for relating a dimension value to a set of business performance measures may have an outlier detection facility that identifies outliers in at least a subset of the one or more KPIs, based on trending of the subset. The platform for relating a dimension value to a set of business performance measures may have an outlier source detection facility that determines if the dimension value contributes to one or more of the outliers by at least one of: (i) generating a KPI for each of the one or more outliers with and without the dimension value and comparing results; or (ii) looking for commonality of the dimension value contributing to two or more of the outliers for distinct KPIs. And the platform for relating a dimension value to a set of business performance measures may have a remedial action selection and initiation facility for remedial action based on an outlier source that contributes to the two or more outliers for distinct KPIs. And wherein commonality of a dimension value for different KPIs can be helpful in determining remedial actions (a specific doctor/product impacting different aspects of a business operation/workflow).

In aspects of the methods and systems described herein, a modular display architecture may have a computing system platform for dynamic measure visualization. The computing system platform for dynamic measure visualization may have a data collection and analysis module for generating measures of activities described in workflows of a business entity. The computing system platform for dynamic measure visualization may have a modular display architecture comprising display groups and individual displays that can be dynamically assigned to measures, wherein each display group represents an organizational category of visualization types. The computing system platform for dynamic measure visualization may have a page identification system whereby each display module is referenced by a unique page identifier that corresponds to a specific visualization implementation. The computing system platform for dynamic measure visualization may have an administrative interface for configuring associations between measures and display groups, enabling expert users to assign specific display modules to measures based on analysis requirements. The computing system platform for dynamic measure visualization may have a user interface that dynamically loads appropriate display modules based on configured associations between selected measures and assigned display groups. The computing system platform for dynamic measure visualization may have an integrated rendering system that processes embedded display content as part of a primary page rendering cycle to improve transition performance between different measures and display types.

In example embodiments, the modular display architecture may enable reuse of display components across different measures while maintaining measure-specific customization capabilities. In example embodiments, the page identification system may support dynamic content loading without requiring separate iframe-based loading mechanisms. In example embodiments, the administrative interface may provide real-time configuration of display assignments without requiring system-wide changes. In example embodiments, the integrated rendering system may include validation mechanisms that operate during data factory construction to ensure data integrity before presentation. In example embodiments, display groups may be organized into multiple organizational categories including trends, definitions, governance, and assisted analytics. In example embodiments, the user interface may provide seamless transitions between display modules by pre-loading associated display components based on user navigation patterns. In example embodiments, the modular display architecture may support both static display assignments and dynamic display selection based on measure characteristics. In example embodiments, the administrative interface may include functionality for removing and reassigning displays to measures through graphical user interface controls.

A modular display architecture may have an integrated portal system with domain management for a cross-business information analysis platform. The cross-business information analysis platform may have a unified portal system that consolidates multiple internal sites and applications into a single access point with integrated single sign-on capabilities. The cross-business information analysis platform may have a domain management system with graphical user interface elements that enable domain configuration, including domain enable/disable functionality accessible through page settings. The cross-business information analysis platform may have permission-based domain access controls that restrict domain visibility based on user roles and organizational hierarchy, wherein different users may be presented with different available domains based on assigned permissions. The cross-business information analysis platform may have domain creation and modification interfaces that enable expert users to define new domains by specifying domain names, organizational indices, and associated measure sets. The cross-business information analysis platform may have dynamic content aggregation whereby various platform components and external tools may be presented through a common interface framework. The cross-business information analysis platform may have authentication bridging technology that enables seamless transitions between different platform modules and external integrated systems without requiring re-authentication.

In example embodiments, the domain management system may support domain duplication and modification workflows for creating variations tailored to specific organizational needs. In example embodiments, domains may be characterized as complex parameter sets that define measure collections, dimensional constraints, filtering criteria, and user interface behaviors. In example embodiments, the permission-based access controls may operate in conjunction with an organizational structure learning module to automatically assign appropriate domain access rights. In example embodiments, the unified portal system may eliminate the need for users to re-enter authentication credentials when accessing different platform components. In example embodiments, the domain creation interfaces may include selection of measures, dimensions, filters, and quick views from available system resources. In example embodiments, the dynamic content aggregation may support addition of new integrated tools without requiring modifications to the core portal framework. In example embodiments, domains can be selectively activated or deactivated based on operational requirements without requiring system-wide changes. In example embodiments, the authentication bridging technology may utilize single sign-on protocols to maintain user sessions across multiple integrated applications.

An enhanced domain configuration and management system for cross-business information analysis may have a domain creation interface that enables expert users to define new domains by specifying domain names, organizational indices, and associated measure sets selected from available system resources. The enhanced domain configuration and management system for cross-business information analysis may have a domain modification interface that may support domain duplication and editing workflows, whereby existing domains can be copied and modified to create variations tailored to specific organizational needs. The enhanced domain configuration and management system for cross-business information analysis may have a domain characterization module that treats domains as complex parameter sets defining measure collections, dimensional constraints, filtering criteria, and user interface behaviors. The enhanced domain configuration and management system for cross-business information analysis may have a domain abstraction engine that enables the same domain framework to be utilized across diverse business entities while maintaining contextual relevance to specific operational requirements. The enhanced domain configuration and management system for cross-business information analysis may have a domain selection interface that may provide access to measures, dimensions, filters, and quick views from available system resources during domain configuration.

In example embodiments, the domain creation interface may include functionality for assigning organizational indices that determine display order and hierarchical positioning of domains within the system. In example embodiments, the domain modification interface may enable copying of existing domain configurations and subsequent editing of copied domains without affecting original domain settings. In example embodiments, the domain characterization module may abstract domains as organizational constructs that can be applied across different data types and business contexts rather than being limited to specific data fields. In example embodiments, the domain abstraction engine may maintain contextual relevance by adapting domain parameters to specific operational requirements while preserving the underlying domain framework structure. In example embodiments, the domain selection interface may provide real-time validation of measure and dimension compatibility during domain configuration to prevent creation of incompatible domain parameter sets.

### BRIEF DESCRIPTION OF THE FIGURES

The disclosure and the following detailed description of certain embodiments thereof may be understood by reference to the following figures:

FIG. 1 depicts a block diagram of a cross-business information analysis and presentation and computing system platform configured to optimize the presentation and analysis of measures associated with the workflows of a business entity.

FIG. 2 depicts a flow diagram of an adaptive intelligence system architecture.

FIG. 3 depicts a flow diagram of adaptive intelligence feedback loop.

FIG. 4 depicts a flow diagram for adaptive assignment of visualizations via a modular display architecture.

FIG. 5 depicts a block diagram of a computing platform for determining relationships among measures of business workflow activities and portions of a business entity.

FIG. 6 depicts a block diagram of a computing platform for relating a dimension value to a set of business performance measures.

FIG. 7 depicts an example user interface of a cross-business information analysis and presentation and computing system platform.

FIG. 8 depicts a graphical user interface of a detail of measure and filter options for a medical leadership domain.

FIG. 9 depicts a surgery leadership domain variant of the graphical user interface of FIG. 8.

FIG. 10 depicts a service line selector for a medical leadership domain of the graphical user interface of FIG. 7.

FIG. 11 depicts presentation of assisted analytics content for a medical leadership domain of a graphical user interface of FIG. 7.

FIG. 12 depicts a graphical user interface for a top level interface of a dimension view embodiment.

FIG. 13 depicts a dimension value selector for a product dimension in a graphical user interface of FIG. 12.

FIG. 14 depicts KPIs in a dimension view of a graphical user interface.

FIG. 15 depicts a tabular listing of KPIs for each dimension value in a selected dimension in a dimension view embodiment.

FIG. 16 depicts a graphical user interface including a dimension selector for performing comparisons among dimensions, dimension values, groups, domains, KPIs and the like.

FIG. 17 depicts a comparison of two dimension values for a primary care provider dimension for a plurality of measures in a dimension view.

FIG. 18 depicts a modular display architecture system.

FIG. 19 depicts an integrated portal system with domain management.

FIG. 20 depicts an enhanced domain configuration and management system.

### DETAILED DESCRIPTION

In a context of operating a hospital or healthcare organization, for example, a cross-business information analysis and presentation and computing system platform may reference a subset of performance measures, such as Key Performance Indicators (KPIs), as a domain. Each domain of KPIs may be specifically relevant to certain roles or departments within the organization. Domains may be dynamically generated and updated based on a relationship between a hospital's organizational structure (e.g., departments like Surgery, Emergency Department, or Medical Leadership), workflows, and employee roles. For example, a “Medical Leadership” domain may present KPIs related to patient outcomes, admission rates, and length of stay, while the “Revenue Cycle” domain may focus on financial KPIs such as billing efficiency, revenue collections, and cost management. Each domain may be displayed through a domain-specific dashboard that is accessible by the relevant staff, such as doctors, department heads, or administrators, enabling them to interact with measures tailored to their specific responsibilities. These dashboards may include predefined static filters, such as time period or department, and dynamic filters that users can customize according to their analysis needs. The dynamic adaptability of domains ensures that the platform presents the most relevant measures for informed decision-making, tailored to each user's role in the hospital.

A group of measures (e.g., KPIs), on the other hand, may organize measures based on common characteristics, objectives, or purposes, rather than being tied to a specific department or role. For example, a “Patient Population” group may include KPIs like AMI (Acute Myocardial Infarction), COPD (Chronic Obstructive Pulmonary Disease), and HF (Heart Failure), which are crucial for evaluating patient care across different specialties. A “Financial” group may include KPIs like inpatient charges and operating margins. Groups allow for analysis of similar KPIs across various parts of the organization, providing insights into specific operational areas like patient care, financial performance, or resource efficiency.

A cross-business information analysis and presentation and computing system platform may include several modules and systems designed to automate the learning, configuration, and presentation of relevant measures. A data collection and analysis module may collect data from various hospital workflows, including patient admissions, medical procedures, financial transactions, and employee activities. The collected data is used to generate performance measures and KPIs, which can then be grouped or categorized into domains or groups for analysis. A user interface may be utilized to present a user-friendly interface that allows staff to interact with KPIs in a domain-specific or group-specific manner. Users can access their domain dashboards and apply filters to view measures specific to their needs, such as a doctor reviewing patient outcomes or an administrator reviewing financial performance. The UI supports both static and dynamic filters to provide flexibility in data analysis. An adaptive intelligence module may learn the hospital's organizational structure, the relationship between different roles and workflows, and the relevance of each measure to various parts of the organization. For example, the system may learn that surgeons frequently access KPIs related to patient outcomes, while finance staff focus on revenue and billing measures. This module continually adjusts the relevance of measures to ensure that the dashboards present data that is most meaningful to users. A measure relevance learning module may identify the use of specific measures by different departments, weighting the importance of those measures based on the roles of employees accessing them. For instance, KPIs related to surgical outcomes might be more heavily weighted for surgical staff than for administrative personnel. The module computes the relevance of each measure, allowing the system to prioritize the display of important KPIs to each department. A domain-set recommendation module may identify measures with high usage within specific domains, suggesting which KPIs should be included in a domain measure-set. For example, if medical staff frequently access KPIs related to infection rates, the system will recommend that these measures be included in the “Medical Leadership” domain. This dynamic process ensures that the most relevant and impactful measures are continuously presented to users. An alert system for KPI monitoring may monitor KPIs and trigger alerts when values deviate from expected thresholds. For example, if patient readmission rates spike above a certain threshold, the system can alert hospital administrators to investigate and take remedial actions. By leveraging artificial intelligence and automated systems, this platform ensures that medical professionals and administrators can access the most relevant data, tailored to their roles and operational needs, enhancing decision-making, improving performance, and enabling proactive management across all levels of the hospital.

In example embodiments, a domain may refer to a subset of measures (e.g., KPIs) that are relevant to a specific portion of an organization, such as a department, role, or functional group. Domains are dynamically generated based on the relationship between the organizational structure, workflows, and the usage of measures by specific roles within the organization. Each Domain may represent a focused view of business performance tailored to the operational or strategic objectives of the individuals or teams within the corresponding organizational segment. In example embodiments, domains may be characterized as complex parameter sets that define not only measure collections but also dimensional constraints, filtering criteria, and user interface behaviors. The platform may treat domains as abstract organizational constructs that can be applied across different data types and business contexts, rather than being limited to specific data fields or organizational departments. This abstraction may enable the same domain framework to be utilized across diverse business entities while maintaining contextual relevance to specific operational requirements.

Domains may be designed to help users access and interact with relevant measures through domain-specific dashboards, which may include predefined or dynamic filters, enabling users to view performance data that aligns with their responsibilities. For example, a “Finance” Domain may include KPIs related to revenue, cost management, and budget forecasts, while a “Medical Leadership” Domain may focus on healthcare-related measures such as patient outcomes, admission rates, and length of stay.

Domains may provide a structured view of data for targeted decision-making and can be configured based on employee roles, responsibilities, or access rights within the organization. Domains may focus on providing relevant measures to a specific portion of the organization based on its role, workflows, and responsibilities

A group may refer to a set of measures that share a common characteristic, purpose, or objective. Unlike Domains, which are tied to specific portions of the organization, Groups are typically organized based on the likeness of measures or the type of data they represent. For instance, a Group may consist of measures that evaluate different aspects of patient populations, financial performance, or operational efficiency.

Groups may not inherently be tied to a specific organizational structure but are rather assembled based on the similarity of data, such as shared metrics, dimensions, or outcomes. For example, a “Patient Population” Group may include measures such as AMI (Acute Myocardial Infarction), COPD (Chronic Obstructive Pulmonary Disease), and HF (Heart Failure), all of which are relevant to patient care, whereas a “Financial” Group might include measures like total revenue, operating margin, and expense ratios.

Groups may be used to organize and analyze related sets of measures for specific purposes, such as tracking performance across similar workflows or objectives, regardless of where these measures apply within the organization. Groups may organizes measures based on shared characteristics or purposes, without necessarily being tied to specific organizational roles or structures.

In example embodiments, any of the platforms described herein may interact with various types of organizational structures, which may range from traditional top-down hierarchies to more fluid structures like transient teams formed for specific projects. For example, a CEO may oversee a structured chain of managers, departments, and individual workers, where the hierarchical structure may be represented as a tree or document. However, not all organizations are rigid; some may create transient teams that disband after completing their purpose. These teams may share responsibilities across multiple departments. The platform may allow users to view data that pertains to their role within the organization. For example, a sales group may need a common view of the organizational data, whereas an individual analyst may require a customized or unique perspective based on their specific responsibilities.

In example embodiments, KPIs (Key Performance Indicators) may serve as essential metrics for measuring different aspects of an organization's performance. Some KPIs may be simple, such as total costs or sales figures, while others may be more complex or derived, such as the average length of stay for patients in a hospital. The platform may recognize the relationship between KPIs and the organizational structure. For example, in healthcare, hundreds of KPIs may exist to monitor various aspects of the business. Each role within the organization may be associated with a specific subset of these KPIs. A senior manager may need access to a broad set of KPIs across departments like surgery, emergency services, and finance, whereas a department head may only require KPIs related to their domain of responsibility.

In example embodiments, measures within any of the platforms described herein may be grouped according to specific purposes or objectives. These groups may not necessarily align with a department but may reflect a particular aspect of operations. For example, a hospital may have a group of measures related to reviewing patient populations, including KPIs such as AMI, COPD, and HF. Another group may focus on financial measures, such as Inpatient Charges and Payment Transaction Amounts. While groups may represent sets of like measures, domains may be tied to specific roles or parts of the organization, reflecting operational objectives. For example, a user belonging to the “ED Operations” domain may have access to measures relevant to the emergency department, and the domain may provide dynamic and static filters to tailor data views to operational needs.

In example embodiments, any of the platforms described herein may leverage business intelligence tools, such as those provided by business intelligence innovators, such as Dimensional Insight, to represent and display complex organizational data. This data may be rendered in dashboards that are organized by domains, with each domain representing a piece of the organization. Domains such as “Medical Leadership,” “Revenue Cycle,” or “Surgery Leadership” may be accessible to users based on their roles and access rights. Users may view measures in groups that align with their responsibilities, and dashboards may support both static filters, which are predefined, and dynamic filters, which may be selectable by the user to refine data further. Executive-level dashboards may also be configured to present high-level summaries across domains in a manner preferred by senior management.

A unified portal system that consolidates multiple internal sites and applications into a single access point with integrated single sign-on capabilities is provided. This portal architecture may eliminate the need for users to re-enter authentication credentials when accessing different components of the platform, thereby improving user experience and operational efficiency. The portal may utilize authentication bridging technology that enables seamless transitions between different platform modules and external integrated systems.

The unified portal may implement dynamic content aggregation whereby various platform components and external tools are presented through a common interface framework. Users may access diverse analytical tools, reporting systems, and data visualization components through standardized navigation elements while maintaining the underlying functionality of each integrated system. This architecture may support the addition of new integrated tools without requiring modifications to the core portal framework.

Domains for any of the platforms described herein may be created or configured by expert users who select the appropriate measures and filters for each domain. This selection process may involve analyzing organizational activities and matching measures that have high usage or relevance to those activities. Once a domain is defined, access rights may be granted to users based on their roles, responsibilities, or areas of focus within the organization. The platform may provide governance tools to manage these access rights efficiently. Domain creation may be simplified to the extent that users can set up or modify domains without requiring IT involvement. This self-service model may enhance operational efficiency by allowing teams to adapt their data views quickly in response to changing business conditions.

Domain creation and modification interfaces may enable expert users to define new domains by specifying domain names, organizational indices, and associated measure sets. The domain configuration process may include selection of measures, dimensions, filters, and quick views from available system resources. Domain duplication and modification workflows may support copying and editing existing domains to create variations tailored to specific organizational needs or user groups.

In example embodiments, the cross-business information analysis and presentation methods and systems described herein, optionally embodied as a platform, may include an integrated domain system that may be configured with graphical user interface elements that enable domain configuration, including domain enable/disable functionality accessible through page settings. The the use of administrative controls, domains can be selectively activated or deactivated based on operational requirements, allowing for dynamic reconfiguration of available measure sets without requiring system-wide changes.

Permission-based domain access controls may be employed to restrict domain visibility based on user roles and organizational hierarchy. Different users may be presented with different available domains based on their assigned permissions, ensuring that sensitive or irrelevant measure sets are not accessible to unauthorized personnel. This permission system may operate in conjunction with the organizational structure learning module to automatically assign appropriate domain access rights based on learned employee role categories and responsibilities.

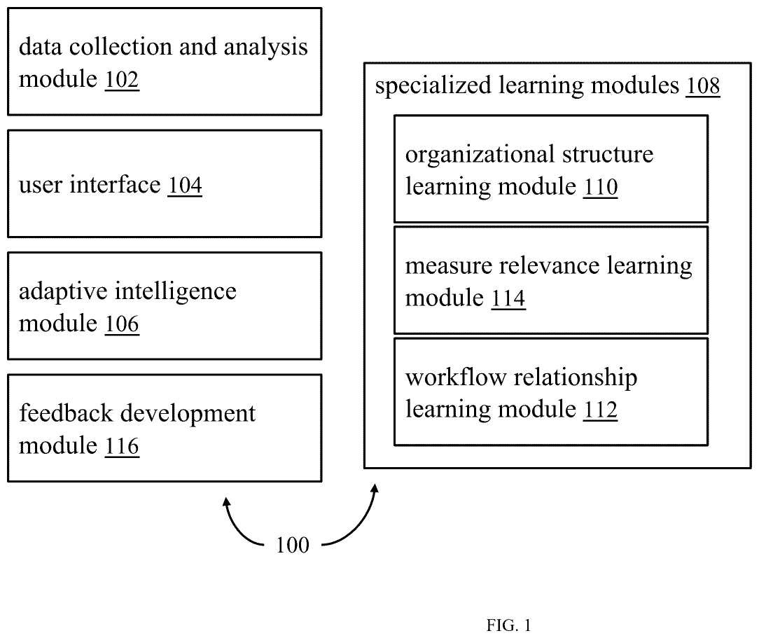

Referring to FIG. 1, in one example, a cross-business information analysis and presentation and computing system platform 100 described herein may be designed to optimize the presentation and analysis of measures associated with the workflows of a business entity, providing insights based on the structure and functioning of the organization. The system may comprise at least three components: a data collection and analysis module 102, a user interface 104, and an adaptive intelligence module 106. Together, these components allow the platform 100 to not only present business-related measures but also dynamically learn and adapt to organizational structures and the relationships between workflows and employee roles, ensuring that the measures presented are relevant and contextually meaningful.

The data collection and analysis module 102 functions as the backbone of the platform 100, gathering data from various sources associated with the activities described in the workflows of a business entity. This module processes the incoming data to generate quantitative or qualitative measures that reflect the performance, efficiency, or status of various business activities. These workflows can span a range of operations within the business, such as supply chain management, customer relationship management, order fulfillment, workflow performance, individual employee performance, or internal project tracking and the like. The generated measures may be stored and categorized, allowing the platform 100 to present them in a structured and meaningful manner.

Validation mechanisms may operate during the data factory construction process, ensuring data integrity and consistency before presentation to end users. These validation processes may be embedded within the underlying data processing architecture, providing automatic verification of data quality and measure calculations without requiring separate validation steps. The validation system may operate transparently to users while maintaining data reliability across all platform functions.

The user interface 104 is accessible via an electronic display connected to and or integrated with the platform, such as a desktop computer, tablet, or other computing resource. The user interface 104 is designed to adaptively represent different sets of measures depending on the user's interaction. Users can select from various groups or domains of measures, based on predefined categories or custom organizational criteria, and the like. Additionally, the user interface 104 includes a series of dynamic measure display filters, allowing users to refine the displayed measures based on specific factors, such as time, resource usage, or workflow completion. These filters provide a level of customization that ensures the measures presented are directly relevant to the user's specific role or current analysis needs. In example embodiments, a modular display architecture may comprise display groups and individual displays that can be dynamically assigned to measures. Each measure may be associated with one or more display groups, wherein each display group represents an organizational category of visualization types. Administrative interfaces may facilitate configuring these associations, allowing expert users to assign specific display modules to measures based on the type of analysis required for each measure.

In example embodiments, a page identification system may be configured, whereby each display module is referenced by a unique page identifier that corresponds to a specific visualization implementation. When a measure is selected through the user interface, the platform may dynamically load the appropriate display module based on the configured associations between the measure and its assigned display groups. This architecture may enable reuse of display components across different measures while maintaining measure-specific customization capabilities.

In example embodiments, enhanced rendering processes for embedded display components may improve transition performance and user experience. Integrated rendering techniques may process embedded content as part of the primary page rendering cycle, rather than relying on separate iframe-based loading mechanisms. This integrated approach may reduce loading times and provide smoother transitions when users navigate between different measures and display types.

The platform may also include the adaptive intelligence module 106, which is responsible for learning and evolving the platform's understanding of the business entity. The module learns an organizational structure of the business entity, and identifies categories of employee roles and their hierarchical or functional relationships, among other things. For example, the adaptive intelligence module 106 may distinguish between management roles, operational roles, and specialized technical roles, understanding how these categories interact with specific workflows within the business.

The adaptive intelligence module 106 also learns relationships between workflows and the organizational structure of a business entity, determining which employee roles are involved in specific workflows or stages of workflows. For instance, it may learn that a certain workflow, such as “customer order processing,” involves roles from both the sales and logistics departments. It further learns the relevance of the generated measures to different portions of the organizational structure by tracking the use and feedback associated with those measures by employees in different roles.

Based on this learning, the adaptive intelligence module 106 can generate sets of measures that are meaningful to specific groups or domains. One approach involves generating sets of measures based on the similarity of data contributing to each measure. For example, measures related to time efficiency may be grouped based on the common dimension of “time spent” across various workflows, regardless of the specific nature of each workflow. In another approach, the system generates sets of measures based on learned relationships between workflows and organizational structures, producing domain-specific insights. For instance, a “logistics efficiency” domain could be created by the adaptive intelligence module 106 based on its understanding of workflows tied to logistics roles and their related performance metrics.

Further a learning process of the adaptive intelligence module 106 is not static. As the platform is used, the adaptive intelligence module 106 may continuously relearn and adjust based on feedback obtained from user interactions with the platform, including interactions through the user interface. For example, if certain measures are consistently filtered out or ignored by users in a particular role, the system adapts by reducing the prominence of those measures for similar users, groups, or domains. Alternatively, if new workflows or roles are introduced to the organization, the adaptive intelligence module 106 integrates these into its learned model, ensuring that the system remains current and relevant.

In example embodiments, a cross-business information analysis and presentation and computing system platform 100 may provide a robust, adaptive tool for dynamically generating and presenting business measures. By leveraging an adaptive intelligence module 106 that continuously learns from user interaction and feedback, the system offers an evolving, customized experience that aligns with the organizational structure and workflows of the business entity.

In another example, the disclosed platform 100 may be designed to assist in organizing and structuring a plurality of business performance measures into overlapping subsets that target operational portions of a business entity. The platform may leverage multiple specialized learning modules 108, each configured to acquire knowledge about the business's organizational structure, workflow relationships, and the relevance of generated measures to different roles and operational segments. The platform 100 may further incorporate feedback mechanisms that adjust the learning modules 108 over time, potentially adapting to the evolving operational environment of the business entity.

In example embodiments, an organizational structure learning module 110 may serve as the mechanism for understanding the business entity's hierarchy and role categories. This module may use a combination of data mining techniques and semantic analysis to extract information from various business resources, such as employee directories, project management systems, or organizational charts. It may categorize employees based on their roles within the organization, distinguishing between functional areas, such as finance, marketing, production, or human resources. Additionally, the module may dynamically update its learning when organizational changes occur, such as the addition of new departments or restructuring of existing ones, ensuring that the platform remains current with the business entity's structure.

The platform 100 may further include a workflow relationship learning module 112, which may learn how workflows are connected to different portions of the organizational structure. This module may rely on graph-based algorithms to map workflows to specific operational segments and determine which roles are responsible for, or impacted by, specific workflows. For instance, the platform 100 may learn that certain workflows, such as procurement or inventory management, span multiple departments like operations and finance. By analyzing activity logs, process maps, and other workflow documentation, the workflow relationship learning module may build an intricate map of how business processes flow through different parts of the organization.

A measure relevance learning module 114 may function to establish which generated business measures are pertinent to particular portions of the organizational structure. The module may track how employees in different roles interact with and utilize these measures. Techniques such as machine learning models for collaborative filtering or content-based filtering may be employed to evaluate patterns of usage by role categories. For instance, it may determine that performance measures related to sales quotas are relevant to sales and marketing roles, while efficiency measures may be more pertinent to production roles. Over time, the platform may refine this understanding, improving its ability to predict which measures will be most valuable to which parts of the business.

Once these learning modules 108 have acquired knowledge about the organizational structure, workflow relationships, and measure relevance, the platform may generate candidate groups of sets of measures. This grouping may be based on either the degree of similarity of the data contributing to each measure and/or a shared dimension of the contributing data that is common across multiple types. In an exemplary example, a vector space model may be employed to calculate similarity between measures based on the attributes of the underlying data. For example, time-based metrics such as “average task duration” and “project completion time” may be grouped together due to their shared temporal dimension, while measures tied to resource utilization may form another group.

In addition to grouping measures based on data similarity, the platform may generate candidate domains of sets of measures. These candidate domains may be constructed based on the learned relationships between workflows, organizational structures, and the relevance of measures to different roles. Domains may represent higher-order groupings of measures that target specific operational aspects of the business. For instance, a domain related to “employee performance management” could include measures relevant to both human resources and department managers, derived from an analysis of workflows tied to employee evaluations, project completions, and departmental productivity.

The platform 100 may also include a feedback development module 116, which may monitor user interaction with the platform to generate feedback. The feedback may be developed by analyzing how users from different roles interact with various sets and domains of measures, including through the user interface. For example, if users frequently modify or filter certain measures, or repeatedly select a particular domain for review, the feedback development module may capture this behavior. This module may employ user interaction data, such as clickstreams, filter selections, and time spent on particular measures or domains, to generate feedback regarding how effectively the system's outputs meet user needs.

In example embodiments, feedback may be used to retrain at least one of the learning modules 108. The retraining process may allow the platform 100 to continuously refine its understanding of the organizational structure, workflow relationships, and measure relevance. For example, if feedback indicates that a certain measure group is frequently ignored by users in a particular role, the measure relevance learning module may adjust its relevance model to deprioritize similar measures for that role in the future. Alternatively, if new workflows are introduced and consistently utilized by a particular department, the workflow relationship learning module may retrain to incorporate this new information, ensuring the system remains relevant to evolving business operations.

In embodiments, the platform may provide a dynamic, intelligent system capable of continually learning and adapting to changes in both the organizational structure and operational needs of a business. The overlapping subsets of measures and generated domains may offer a targeted, context-aware presentation of business performance data, while the feedback and retraining mechanisms may ensure that the platform 100 evolves in line with user interactions and operational demands.

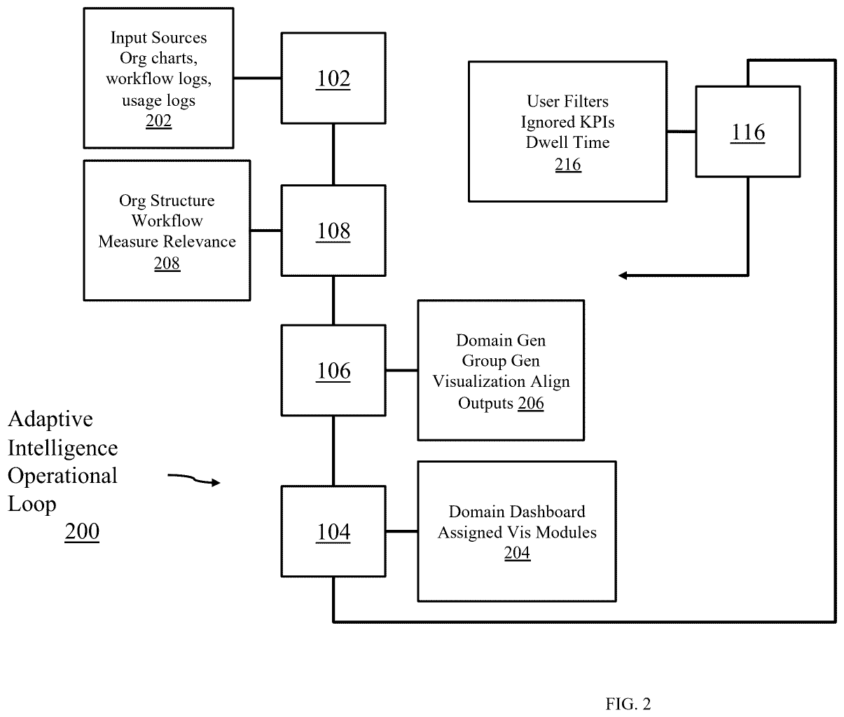

FIG. 2 illustrates an expanded architecture 200 of an adaptive intelligence system for dynamically generating and presenting business measures. A plurality of input sources 202 provide data to the system, including organizational charts, workflow execution logs, user interaction/usage logs, and the like. These data inputs 202 are processed by specialized learning modules 108, including an organizational structure learning module, a workflow relationship learning module, a measure relevance learning module, and the like. The outputs of these learning modules 108 feed into an adaptive intelligence core 106. The adaptive intelligence core 106 generates outputs 206 including candidate domains, groups of measures, and assignments of visualization types based on learning data 208 including learned organizational relationships, workflow associations, and measure relevance. The core 106 further produces outputs 206 to a user interface 104, which renders domain-specific dashboards and dynamically assigned visualization modules 204. A feedback module 116 collects user interactions 216 such as applied filters, ignored key performance indicators (KPIs), and dwell times, and feeds these metrics back into the learning modules for retraining, thereby closing the adaptive loop 200.

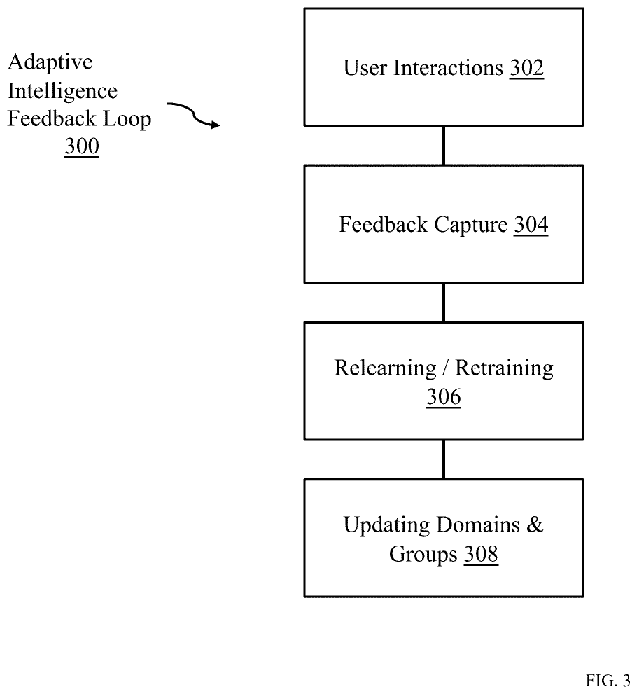

FIG. 3 illustrates a feedback loop process 300 for adaptive intelligence. User interactions 302 with displayed measures and filters are collected and passed into a feedback capture module 304. The feedback is analyzed to identify user preferences, relevance of measures, and patterns of engagement. A relearning or retraining process 306 is then applied to the organizational structure, workflow, and measure relevance learning modules. The retrained modules update 308 domain and group definitions, which are supplied to the user interface 104 and influence subsequent iterations of the system's outputs. In this way, the adaptive intelligence system 106 continuously evolves its understanding of organizational needs and measure relevance.

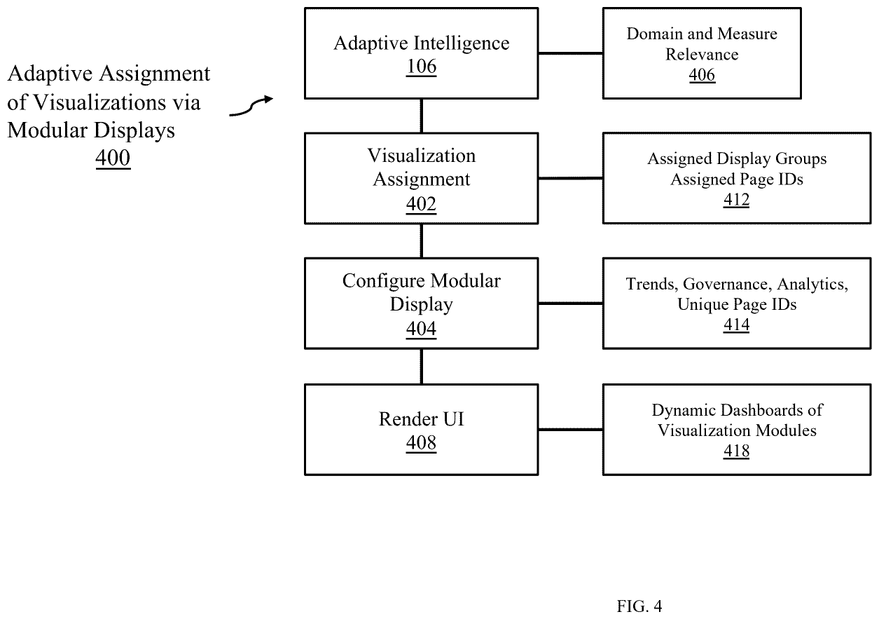

FIG. 4 illustrates adaptive assignment of visualizations through integration of adaptive intelligence with a modular display architecture 400. The adaptive intelligence core 106 generates outputs 406 identifying domains and associated measures, together with relevance metadata. A visualization assignment module 402 maps these measures to appropriate visualization categories 414, such as trends, governance views, or analytics, and assigns each measure to a unique page identifier (page ID) 412 corresponding to a specific display module. These assignments are passed into a modular display architecture that organizes display groups and individual display modules 404. The rendered user interface 408 displays dynamically assembled dashboards 418 that include visualization modules pre-selected based on adaptive intelligence outputs, thereby eliminating the need for manual administrative configuration and enabling seamless transitions between visualization types.

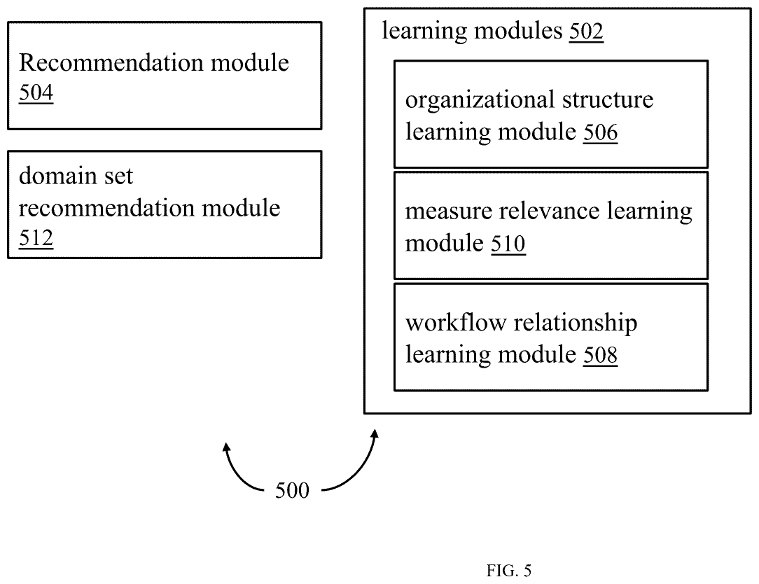

Referring to FIG. 5 in an example, a relationship determination platform 500 may be designed to determine relationships among measures of business activities described in workflows of a business entity and portions of the organizational structure of the business entity. The platform 500 may leverage several learning modules 502, each focused on understanding the organizational structure, workflow relationships, and the relevance of various business measures. This platform 500 may also include a recommendation module 504 that provides targeted suggestions based on the usage of measures by different roles and segments of the business.

The platform may include an organizational structure learning module 506 that may learn the organizational structure of the business entity, including categories of employee roles. This module 506 may operate by extracting and analyzing data from business management systems, organizational directories, and project management tools. It may categorize employees into distinct roles, such as executive, managerial, operational, or technical, mapping the hierarchical or functional structure of the organization. This module 506 may also adapt to changes within the organization, updating its model when new roles or departments are added.

In addition, the platform 500 may include a workflow relationship learning module 508, which may learn how workflows are connected to various portions of the organizational structure. This module 508 may use data analysis techniques, including mapping algorithms, to observe which employees or departments are involved in specific workflows. For example, the platform may learn that a particular workflow, such as “patient admissions,” involves both the medical team and the insurance team. By analyzing process data and employee engagement with workflows, this module 508 may form a detailed understanding of the relationships between organizational roles and business processes.

The platform 500 may further incorporate a measure relevance learning module 510, which may determine the relevance of generated measures to specific portions of the organizational structure. This module 510 may observe how employees across different roles access and use various measures to track business performance. The process may involve identifying the use of measures by a plurality of portions of the organizational structure based on access patterns, such as when employees from different departments frequently interact with a particular measure. The platform 500 may track these interactions over time, identifying trends and correlations between employee roles and their use of specific business measures.

To refine this relevance determination, the platform 500 may implement a weighting process, whereby the use of measures is weighted based on the category of the role of each employee accessing a measure. For example, access by an executive surgeon may be weighted more heavily than access by a medical assistant, given the potential broader impact of executive decision-making. The module 510 may assign different weights depending on the employee's level of influence within the business or their proximity to strategic decision-making processes.

Using these weighted interactions, the platform 500 may calculate a degree of measure usage for each measure by each of the portions of the organizational structure. This calculation may be based on computing the observed access in combination with the applied weighting factors. For instance, a measure related to revenue forecasting may be more heavily weighted when accessed by a financial manager than when accessed by an administrative staff member. The platform may thus generate a quantitative assessment of how frequently, and with what significance, specific portions of the organization engage with particular business measures.

The platform 500 may also include a domain-set recommendation module 512, which may determine a usage measure threshold for at least one portion of the organizational structure. This threshold may serve as a criterion for identifying candidate measures for inclusion in a domain-specific measure set. The recommendation module 512 may analyze the calculated degree of measure usage and identify those measures that surpass the threshold, flagging them as potentially relevant for inclusion in a specific domain.

Once these candidate measures have been identified, the platform 500 may generate a domain measure-set that is targeted to specific portions of the organizational structure. This measure-set may be made accessible to a portion of the employees within that organizational segment, such as managers or departmental leads, and presented within a domain-specific dynamically rendered dashboard. This dashboard may be available through an electronic user interface, providing real-time access to the most relevant business measures for the targeted users. The dashboard may be designed to adaptively update the presented measures based on user interaction or changes within the business workflows, ensuring that the platform continues to provide relevant and actionable insights.

In example embodiments, the platform 500 may facilitate the determination of relationships between business measures and organizational roles, leveraging advanced learning modules to continuously refine and improve the relevance of the data presented. By utilizing weighted access data, calculated measure usage, and domain-specific recommendations, the platform may offer tailored insights that align with the needs of different segments of the business entity.

In example embodiments, the platform 500 may allow for an expert user to finalize the domain measure-set by selecting a fixed set of measures, establishing fixed filters, and incorporating at least one user-selectable dynamic filter. This refinement offers an additional layer of customization, enabling an expert, such as a department head or data analyst, to exercise discretion in defining the measures and filters that will be available within a domain-specific dashboard. The expert may have specialized knowledge of the operational goals or strategic objectives of the business entity, which allows them to tailor the domain measure-set more precisely to the needs of the users within a particular organizational segment.

The platform 500 may provide the expert user with access to a list of candidate measures that have been generated based on the previously calculated measure usage and relevance, as described in the base claim. From this list, the expert may be able to select a fixed set of measures for inclusion in the finalized domain measure-set. This selection process may involve reviewing the degree of usage and relevance of each candidate measure, as determined by the platform's learning modules, and applying the expert's judgment to ensure that only the most appropriate and meaningful measures are included in the final set. The fixed nature of these selected measures ensures consistency in reporting and analysis for users accessing the domain-specific dashboard.

In addition to selecting measures, the expert may define a fixed set of filters that will apply to the domain measure-set. These fixed filters may be used to pre-configure the display of measures according to specific criteria, such as time periods, geographical regions, or business units. For example, an expert user may choose to apply a fixed filter to display performance measures for a particular quarter or for a specific department within the organization. The use of fixed filters provides standardized views of the data, ensuring that all users of the domain-specific dashboard access the same baseline information.

Finally, the platform may allow the expert to incorporate user-selectable dynamic filters into the domain measure-set. These dynamic filters may enable individual users to interactively customize their view of the data by applying filters relevant to their specific needs or interests. For instance, a dynamic filter could allow users to adjust the time range or focus on specific product lines or regions. By providing a combination of fixed and dynamic filters, the platform balances the need for consistent, expert-defined reporting with the flexibility required for users to explore the data in ways that are most meaningful to their roles. This interactive capability may enhance user engagement and enable more granular analysis of business activities within the domain-specific dashboard.

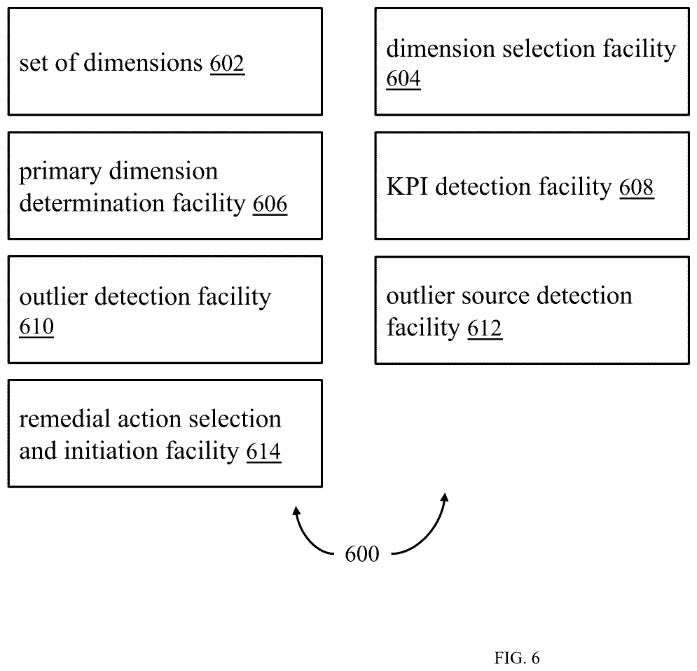

Referring to FIG. 6, in example embodiments, a platform 600 may be designed to relate a dimension value to a set of business performance measures. The platform 600 may operate by utilizing multiple facilities that handle various aspects of business data entries, including identifying dimensions, determining key performance indicators (KPIs), detecting outliers, and initiating remedial actions when necessary. This platform may support a business entity's ability to monitor and optimize performance by analyzing how specific dimensions of business data influence KPIs and identifying corrective measures when deviations from expected results occur.

The platform 600 may include a set of dimensions 602 that characterize business data entries used to calculate business performance measures. Each business data entry may be associated with one or more dimensions, and each dimension may represent a specific attribute of the business data, such as time, geography (e.g., hospital, warehouse), or product/service category (e.g., electrical generator/surgical procedure). Each data entry characterized by a dimension may represent a value of the corresponding dimension (referred to herein optionally as a “dimension value”), which may serve as the actual instance or value of the dimension. For example, a data entry with a “hospital” dimension may have a dimension value of “Miriam Hospital” The platform 600 may leverage these dimensions to perform further analysis on business performance measures.

The platform 600 may also include a dimension selection facility 604, which may receive business data entries and produce one or more dimension identifiers based on the set of dimensions. This dimension selection facility 604 may automatically process incoming data entries and match them to appropriate dimensions, based on predefined business rules or metadata associated with the data. For instance, a data entry containing a timestamp of a patient admission may be automatically assigned an “admission” dimension, while a sales transaction may be linked to “product” and “region” dimensions. This dimension selection process may enable the platform 600 to categorize data effectively and ensure that all relevant attributes are identified for analysis.

Once dimensions are identified, the platform 600 may feature a primary dimension determination facility 606, which may determine a primary dimension for each business data entry. This determination may be based on the utilization of the business data entry as a dimension value for the primary dimension. For example, in the case of a sales transaction, the platform may determine that “product” is the primary dimension, as the performance of individual products may have the most significant impact on business performance. This facility may enable the platform 600 to focus on the most relevant dimension for each data entry, which may in turn drive the analysis of key performance indicators (KPIs) and allocation of KPIs to groups and domains.

The platform 600 may further include a KPI detection facility 608, which may determine one or more KPIs that are impacted by the primary dimension. This determination may be based on a business rule or a description of how KPIs are calculated. For instance, the KPI detection facility 608 may identify that revenue growth, inventory turnover, and profit margins are impacted by the “product” dimension, and may track how changes in product-related data entries affect these KPIs. By linking the primary dimension to relevant KPIs, the platform 600 may help businesses understand how specific aspects of their operations contribute to overall performance metrics.

To monitor and flag potential issues, the platform 600 may incorporate an outlier detection facility 610, which may identify outliers in at least a subset of the KPIs. Outlier detection may be based on trending the subset of KPIs over time, where significant deviations from expected values are flagged for further review. For example, if the sales of a particular product experience an unusual spike or drop that falls outside of historical trends, the platform may identify this as an outlier. Detecting such outliers may enable the business to investigate underlying causes and take corrective actions as needed.

When an outlier is detected, the platform 600 may include an outlier source detection facility 612 to determine whether the dimension value contributes to one or more of the outliers. This facility may operate by employing one or both of the following approaches: (i) generating a KPI for each of the outliers both with and without the dimension value, and then comparing the results to determine the dimension's impact, or (ii) looking for commonality of the dimension value contributing to two or more outliers across distinct KPIs. For example, if a sudden drop in sales and an increase in product returns are both linked to a specific “region” dimension value, the platform may infer that the region is contributing to the observed outliers.

Further, the platform may feature a remedial action selection and initiation facility 614, which may suggest or initiate remedial actions based on the identified outlier source. If the platform determines that the same dimension value contributes to two or more outliers across distinct KPIs, it may recommend appropriate corrective actions. For instance, if a specific region is found to be the common source of poor sales and high product returns, the platform may suggest adjusting the supply chain, launching a marketing campaign in the region, or reevaluating the product offering. These remedial actions may be initiated directly by the platform 600 or presented to business decision-makers for manual execution, enabling the business to address performance issues in a timely and targeted manner.

Relationships between portions of an organization and measures, including KPIs may be viewed from a perspective of the organization. In example embodiments, the methods and systems described herein for cross-business information analysis and presentation may dynamically relate portions of a business organization, such as departments, individual roles, or cross-functional management groups, to relevant KPIs through an intelligent, autogenerated graphical user interface (GUI) such as a dashboard. A cross-business information analysis and presentation platform having the methods and systems described herein for cross-business information analysis and presentation may analyze the structure of the business organization, such as to identify one or more distinct portions or groups, including functional teams like finance, marketing, or IT, hybrid groups such as medical leadership or surgery leadership, as well as individual roles such as department heads or cross-functional leadership positions.

Each portion of the organization may have unique relationships with a plurality of KPIs that reflect its workflow and responsibilities. For example, the finance department may have a set of KPIs focused on revenue generation, cost management, and financial forecasting, while the marketing team may prioritize KPIs related to lead generation, customer acquisition, and brand awareness. Cross-functional management roles may be interested in high-level, aggregated KPIs that span multiple departments, offering a holistic view of overall business performance.

The cross-business information analysis and presentation platform may use this organizational information to automatically generate a dynamic dashboard that is customized for the needs of each portion of the organization. The dashboard may display the KPIs that are most relevant to that specific team or role, pulling in data from various workflows and operational activities across the organization. For instance, the dashboard for a department head may present a detailed view of KPIs like employee efficiency, departmental budgets, and project completion rates, while a cross-functional manager's dashboard may provide a consolidated view of KPIs across departments, enabling broader decision-making.

A graphical interface in which the dynamic dashboard may be presented may also offer the ability to filter and drill down into specific KPIs through both static and dynamic filters. For example, a user may filter the KPIs by time period, region, or specific projects. By tailoring the interface to the needs and responsibilities of different portions of the organization, the platform may enhance decision-making and performance monitoring across various levels of the business.

Relationships between portions of an organization and measures, including KPIs may be viewed from a perspective of the measures/KPIs. In example embodiments, the methods and systems described herein for cross-business information analysis and presentation may take KPIs as the central focus and relate them to specific portions of the organization through an autogenerated dashboard that adapts to the relationship between the KPIs and organizational roles. A platform having the methods and systems described herein for cross-business information analysis and presentation may analyze the KPIs that are used to track the performance of various business workflows. These KPIs may range from operational measures like productivity rates or quality control statistics to financial KPIs such as profit margins or budget utilization, and the like.

Each KPI may have different degrees of relevance to specific portions of a business organization. For instance, a KPI measuring sales growth may primarily be of interest to the sales and marketing teams, but it could also be relevant to financial analysts who monitor revenue streams. Similarly, KPIs related to employee engagement and retention may be crucial to the human resources department but could also be monitored by departmental managers who want to maintain team performance.

The cross-business information analysis and presentation platform may also dynamically (and automatically) generate a dashboard that presents these KPIs to the relevant portions of the organization. This dashboard may adapt based on the relationships between the KPIs and the organizational structure, ensuring that the data presented is meaningful to the user's role. For example, when a manager from the HR department accesses the dashboard, the system may prioritize KPIs related to employee satisfaction, recruitment costs, and turnover rates. In contrast, when a member of the sales team logs in, the dashboard may focus on KPIs related to lead conversion rates, customer retention, and revenue targets.

An autogenerated dashboard may also provide flexibility by allowing users to personalize their view of KPIs through dynamic filters that match their specific interests or ongoing projects. For instance, a department manager may filter the KPIs to focus on their team's performance over the last quarter, while a project leader may zoom in on KPIs related to the specific project's budget and timeline. The platform's ability to dynamically link KPIs to the appropriate organizational roles and workflows ensures that users always have access to the most relevant and actionable data.

The methods and systems described herein for cross-business information analysis and presentation may be structured to facilitate a dimension-centric view of the business. Key aspects of the methods and systems described herein may include dimension-centric data discover, KPIs and business rules, dynamic views and filters, standard information display capabilities/modules, KPI monitoring and alert system, and the like. Each of these five aspects are now described.

In embodiments, a cross-business information analysis and presentation platform may employ a dimension-centric approach to data discovery, focusing on dimensions as key attributes that categorize business data. As described throughout this disclosure, a dimension may represent a type of data, such as “surgeon” or “hospital,” and each dimension may have associated dimension values that correspond to specific instances, such as a particular doctor's name or the name of a hospital. By focusing on dimensions, the cross-business information analysis and presentation platform may allow users to dive into KPIs related to these dimension values. For example, a hospital administrator may analyze the performance of various doctors by selecting the “doctor” dimension and observing which KPIs are impacted by individual or grouped doctor names.

The cross-business information analysis and presentation platform may also facilitate dimension-centric data analysis by first identifying a primary dimension associated with each piece of business data. For instance, in healthcare, a doctor's name may be identified as a primary dimension for a patient's length of stay or mortality data. After determining the primary dimension, the platform may analyze a variety of KPIs that relate to the dimension, allowing the user to investigate how different dimension values (e.g., specific doctors) contribute to business outcomes. The platform may also evaluate KPIs to detect outliers by comparing trending rates for KPIs influenced by a dimension. For example, a hospital may compare the performance of multiple surgeons by analyzing trends in patient outcomes or resource usage.

In embodiments, a cross-business information analysis and presentation platform may leverage business rules to derive KPIs from raw business data. KPIs such as average length of stay in a hospital or patient mortality rate may be calculated by applying rules to data dimensions like admission types or treatment records. Each KPI may depend on one or more business data points, representing the real-world performance of organizational workflows. For example, the cross-business information analysis and presentation platform may calculate an average length of stay by using data related to patient admissions and discharge dates, where the length of stay serves as a dimension value.

To enhance performance monitoring, the cross-business information analysis and presentation platform may offer tools to evaluate KPIs by analyzing the impact of dimension values. For instance, the cross-business information analysis and presentation platform may allow users to compare KPI outcomes both with and without specific dimension values, such as generating a patient outcome KPI with and without the involvement of a specific surgeon. This comparison may reveal whether the dimension value (e.g., a doctor's name) contributes to outlier KPIs. The cross-business information analysis and presentation platform may also detect commonality across multiple KPIs, such as a doctor impacting both patient length of stay and mortality rates. By identifying these relationships, the cross-business information analysis and presentation platform may help users pinpoint areas for remedial action, such as revising workflows or addressing performance issues related to specific dimension values.

In embodiments, a cross-business information analysis and presentation platform may support dynamic views that allow users to filter KPIs and dimensions based on specific domains, such as “sales” or “medical leadership.” Users may first select a relevant domain, which constrains the available dimensions to those most relevant to the chosen context. For example, in the sales domain, the available dimensions may include customer, product, and category, allowing users to analyze KPIs related to sales performance in various contexts.

Additionally, users may select specific dimension values within a domain to compare KPI performance across multiple elements. For example, in the medical domain, a user may compare KPIs for multiple primary care providers by selecting the “Primary Care Provider” dimension and viewing a set of selected providers. The ability to change focus within a dimension allows users to explore the performance of a specific subset of products or services in a particular domain, offering a flexible and intuitive way to analyze organizational performance from different perspectives.

In embodiments, a cross-business information analysis and presentation platform may offer a Standard Information Display that provides a consistent approach to viewing KPIs across different industries and organizational domains. This platform may support the display of KPIs in various formats, including numerical representations that show the current value of a KPI, trend visualizations that highlight historical performance, and definitions that explain how each KPI is calculated and its significance to the business.

Users may access these KPI displays through domain-specific views, where each domain, such as sales, healthcare, or finance, offers a curated set of KPIs relevant to that operational area. In the sales domain, for instance, a set of 18 KPIs may cover various aspects of sales performance, including customer retention, product sales, and revenue growth. By presenting KPIs in a structured, user-friendly manner, the platform may facilitate improved decision-making and operational efficiency across diverse business areas.

In embodiments, a cross-business information analysis and presentation platform may feature an Alert System that monitors KPIs and automatically generates alerts when performance deviates from expected thresholds. Initially, these alerts may be based on conventional thresholds, such as when a KPI exceeds or falls below a predefined value. For example, a hospital's patient admission rate may trigger an alert if it exceeds typical seasonal levels, enabling administrators to take timely action.

In more advanced configurations, such a platform may employ machine learning to automatically configure alerts based on patterns in the data, such as dimension values that consistently impact KPIs. For instance, if a particular doctor's performance frequently correlates with negative outcomes across multiple KPIs, the system may generate an alert indicating potential performance issues. This capability enables the cross-business information analysis and presentation platform to provide more nuanced, data-driven insights, helping users stay informed about critical business trends and potential areas of concern.

Artificial intelligence capabilities may be integrated into the core system architecture, providing enhanced analytical capabilities and user interaction features. The AI integration may include chat-based interfaces that enable users to interact with the platform using natural language queries and commands. The AI system may be configured to understand measure definitions, dimensional relationships, and domain structures, enabling intelligent responses to user inquiries about data relationships and analytical insights.

The AI integration may further provide navigation assistance whereby users can traverse the platform interface using conversational commands rather than traditional menu-based navigation. The AI system may be trained on the platform's data structures and organizational relationships, enabling it to provide contextually appropriate suggestions and automated analytical workflows based on user roles and historical usage patterns. This AI-enhanced interaction model may reduce the learning curve for new users while providing advanced analytical capabilities for experienced users.

In example embodiments, artificial intelligence systems may be applied to various functional modules and capabilities of the cross-business information analysis and presentation platforms as described herein. Below are example embodiments of artificial intelligence-based systems performing platform functions.

As a first artificial intelligence-based example, an AI system may perform various actions of an adaptive intelligence module as described herein, depicted in figures herein, and as variously claimed herein.

In this example, the adaptive intelligence module may rely on artificial intelligence, specifically a deep learning network, to perform the core actions of the adaptive intelligence module as described herein. The AI system may consist of a neural network trained to learn and model the organizational structure, the relationships between workflows and portions of that structure, and the relevance of generated measures to different parts of the organization.

The AI system may receive as input a diverse set of data related to the business entity, including: employee role data, such as names, departments, hierarchy levels, and responsibilities of employees; workflow data, such as descriptions of workflows, tasks completed, time logs, and interdepartmental interactions; business performance data: KPI results, operational metrics, and measure sets reflecting productivity, efficiency, and other performance factors, and the like. For example, in a healthcare organization, the input data may include employee records (doctors, nurses, administrators), workflows related to patient admission and discharge, and performance data such as patient turnover rates and average length of stay.

A deep learning network may aim to: learn the organizational structure by categorizing employee roles based on hierarchy and responsibilities. For example, it could determine that doctors, nurses, and administrative staff belong to different categories, each with different workflows and associated KPIs; identify relationships between workflows and specific portions of the organization. For instance, workflows related to patient care might be linked primarily to doctors and nurses, while financial workflows might be linked to the administrative staff; and determine the relevance of generated measures to specific employee roles. For example, the system may find that certain KPIs (e.g., patient satisfaction scores) are more relevant to the medical staff than to the finance team.

In this and other exemplary embodiments described herein an adaptive learning process may be utilized. In example embodiments, an AI system may use unsupervised learning techniques such as clustering to group employees into categories based on their roles and workflows. For instance, the deep learning network may discover that employees who frequently interact with patient records are part of a group related to direct patient care, while those who focus on billing belong to the financial department. Similarly, it can identify KPIs that are consistently used by specific departments, creating a more relevant set of performance measures for each role.

In example embodiments, feedback and improvement may be achieved due at least in part to a platform that continuously observes user interactions with the displayed measures and records how users interact with different dynamic filters (e.g., time periods, departments, or specific workflows). This feedback may include: frequency of KPI selection by users in different roles; user-initiated filter adjustments, indicating which measures are considered most useful by employees; time spent reviewing specific KPIs, which may suggest the relative importance of certain metrics, and the like.

Based on analysis of this feedback, an AI system relearns and refines its understanding of, for example, the organizational structure, workflow relationships, and relevance of KPIs. For example, if employees in a department consistently adjust filters to focus on specific KPIs, the system may automatically prioritize those KPIs in future iterations. Over time, the system may improve the relevance of the measures presented to each employee, offering more tailored dashboards and better data-driven insights for decision-making.

In a second example of use of AI, the role of artificial intelligence focuses on the configuration (training) and reconfiguration (retraining) of the adaptive intelligence module itself. An AI system in this case may be responsible for setting up the initial learning parameters, training the module on historical data, and periodically retraining the system based on new data and user feedback.

For configuration and training, an AI system may be given a historical dataset, including: past organizational data such as historical records of employee roles, team structures, and organizational hierarchies; workflow data, such as previous workflows completed within the organization, including task assignments, completion times, and interdepartmental dependencies; KPI performance data, such as past performance measures, including KPIs associated with various parts of the organization, like sales revenue, employee productivity, or patient outcomes, and the like. In an example, in a retail business, the training data might include past sales workflows, sales performance metrics, and employee hierarchy data for different store branches.

An AI system that focuses on the configuration (training) and reconfiguration (retraining) of the adaptive intelligence module may initially aim to: train the adaptive intelligence module to identify relevant patterns in how KPIs are associated with different workflows and parts of the organization; configure the module to recognize relationships between measures of workflow activities and portions of the organizational structure, such as specific teams or departments that regularly interact with certain business processes; establish baseline rules for the relevance of KPIs to different roles based on historical data, ensuring that the system starts with a reasonably accurate understanding of which KPIs matter most to different employee categories, and the like.

As the adaptive intelligence module is used over time, the AI system may continuously retrain the adaptive intelligence module based on feedback collected from user interactions. Feedback might include; user input, such as user feedback, such as survey responses indicating the usefulness of specific KPIs; interaction data, such as indirect feedback, such as how often users view or ignore certain KPIs or change filters; performance outcomes, such as changes in business performance that can be attributed to the use of certain KPIs (e.g., an increase in efficiency after employees began focusing on a particular KPI).

Such an AI system may analyze this data and reconfigure the module by adjusting learning weights or updating neural network models. For example, if the system detects that a KPI related to customer satisfaction is being consistently prioritized by employees in customer service roles, it may increase the weight of that KPI in the module's relevance calculations. Additionally, if the feedback shows that the relevance of certain KPIs has changed over time (e.g., due to organizational restructuring), the AI system can retrain the module to reflect these new relationships.

An AI-driven retraining process may allow the adaptive intelligence module to make continuous improvements. In example embodiments, an initial goal may be that the adaptive intelligence module might begin by associating KPIs like “monthly sales revenue” only with the sales team. As the system collects feedback data, it may learn that KPIs related to sales revenue are also valuable for financial analysts and senior managers. This may enable improvement of the adaptive intelligence module by, for example the AI system retraining the module to expand the relevance of sales KPIs to additional roles, providing more comprehensive data across departments. Over time, this retraining may enable the platform to remain up-to-date with changes in organizational structure, workflow dynamics, and KPI relevance, improving its adaptability and effectiveness in supporting business decisions.

A third artificial intelligence enabled example may include use of an AI system to perform action of a measure relevance learning module as described herein. In this example, the measure relevance learning module utilizes a deep learning artificial intelligence system, such as a neural network, to autonomously perform the core actions of identifying, weighting, and calculating the relevance of measures to different portions of an organization's structure. The AI system analyzes access patterns and usage data to understand how different employee roles engage with various measures (KPIs) and how these engagements inform the relevance of those measures to different parts of the organization.

The AI system may process input from several sources including employee interaction logs that may capture data on how employees access and interact with measures, including the frequency of access, time spent viewing specific KPIs, and any filtering or customization actions performed by the employee. A second source may cover role-based data, such as information about employee roles, their responsibilities, and their organizational hierarchy is provided as input. This data helps to categorize employees according to their functional areas (e.g., management, operations, finance). A third source may cover measure data definitions, such as descriptions of the generated KPIs, including their attributes and how they are calculated from workflow data, may also serve as input to the AI system. In a manufacturing company example, the input data may include logs of how production managers, line workers, and supply chain coordinators interact with KPIs related to production efficiency, machine uptime, and order fulfillment rates.

An AI system's initial goals for performing actions of the measure relevance learning module may include: identifying the use of measures by observing employee interaction with the system. For example, the system might analyze which KPIs (e.g., production efficiency, cost per unit) are frequently accessed by employees in the production department. Another goal may include weighting the use of measures based on the roles of the employees accessing them. A role such as “Operations Manager” might carry more weight in the context of production-related KPIs than a role such as “HR Coordinator.” A third goal may include calculating the degree of measure usage by multiplying the observed access data by the weightings assigned to different employee roles, providing a weighted measure usage score for each portion of the organization.

In example embodiments, an AI system may use neural networks to model how different roles within the organization interact with KPIs. For example, a production manager's frequent access to a machine downtime KPI may carry more weight in the system than a factory worker's occasional access to the same KPI. Over time, the AI system may refine its model of measure relevance based on observed patterns, improving the accuracy of its relevance calculations. Additionally, as organizational roles evolve or new KPIs are introduced, the AI system may adjust the weightings and measure usage scores accordingly.

An AI system may continuously learns from feedback to improve the measure relevance learning module. Feedback may include direct feedback, such as employees may provide explicit feedback on the usefulness of particular KPIs, allowing the system to adjust the weighting accordingly; indirect feedback, such as the AI system may observe patterns such as employees frequently accessing or ignoring certain measures. For instance, if employees in the finance department consistently ignore a KPI related to customer service response times, the system may reduce the relevance of that KPI for finance roles, and the like.

Through an exemplary feedback loop, the AI system may improve the measure relevance learning module's model of measure relevance over time. For example, after several iterations, the system may learn that production efficiency KPIs are of high relevance to both production managers and supply chain coordinators, but not to HR staff, and adjust the display of KPIs accordingly.

A fourth artificial intelligence-based example may include performing actions of the domain-set recommendation module as described herein.

In this example, the domain-set recommendation module is configured to rely on a neural network-based artificial intelligence system to autonomously determine which measures meet or exceed a predefined usage threshold and should be included in a domain measure-set. The AI system may analyze employee interactions with various measures, evaluate how these interactions vary across different portions of the organization, and then generate candidate domain-specific measure-sets based on the results.

In example embodiments, various sources of data may be input to an AI system. Examples include: employee interaction logs that may reflect how employees across different organizational roles interact with the KPIs, including access frequency, filters applied, and time spent analyzing specific measures; organizational role data detailing the hierarchy and structure of the business, including which roles exist, their responsibilities, and how employees from different departments interact with business workflows; measure usage statistics that may represent aggregated data that tracks how often specific measures (KPIs) are accessed or utilized across different portions of the organization, and the like.

For instance, in a healthcare system, the domain-set recommendation module might analyze how medical staff, administrative employees, and financial analysts access different KPIs, such as patient admission rates, revenue cycle efficiency, and surgical outcomes.

An AI system for autonomously determining which measures meet or exceed the predefined usage threshold may perform actions including: identifying measure patterns across different organizational segments, such as by tracking down that doctors frequently access KPIs related to patient care, while financial analysts focus on billing and revenue cycle metrics; determining usage thresholds for each portion of the organization, such as by using statistical analysis and clustering to calculate a baseline for measure usage and identify outliers that suggest higher relevance to specific roles or departments; generating domain-specific measure-sets by selecting measures that exceed the predefined usage thresholds for specific portions of the organization.

In example embodiments, a deep learning model may be used to learn measure usage patterns over time. For example, if a specific KPI related to patient readmission rates is consistently accessed by medical professionals in different departments, the system may assign higher relevance to that KPI for medical domains. The system can also use clustering algorithms to group similar measures together and recommend these groups as part of a cohesive domain measure-set.

The AI system may improve performing actions of the domain-set recommendation module based on feedback. Examples of feedback may include: direct feedback from user who provide input on the relevance of recommended measures, helping the system adjust the measure-set configuration; observed adjustments, such as if the AI system tracks when users modify or filter specific KPIs, suggesting a need to reprioritize those KPIs in future domain measure-sets; measured usage patterns that may be derived from monitoring how frequently recommended measures are accessed within a domain for adjusting the measure-set if usage drops or shifts.

For example, if the system recommends a KPI related to surgical performance, but users frequently filter out that KPI, the AI may adjust its weight in future recommendations. Through this feedback loop, the AI system refines the domain measure-sets, ensuring that the most relevant KPIs are always included for specific employee roles or departments.

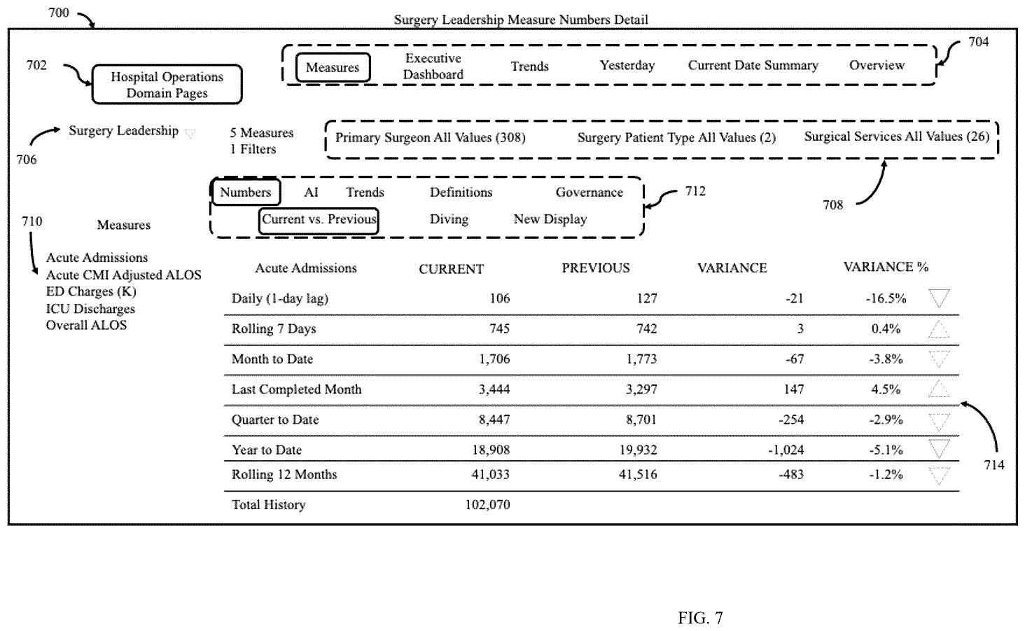

Referring to FIG. 7, an example UI includes a plurality of function-specific sections, including without limitation: A top level perspective selector 702, a top level information display type selector section 704, a domain selector section 706, a filter selector section 708, a measures selection section 710, a results type display selector portion 712, and a results portion 714.

A top level perspective selector 702 facilitates selection of which top level perspective is being taken of the data; options include “domain pages”, “groups”, and the like. The top level information display type selector section 704 includes a set of selectors for generating selected results. These include Measures, Dashboard (e.g., executive), Trends, Timeframe (e.g., yesterday), Summary (e.g., Current Date Summary), Overview, and the like.

For simplicity of description alone, the remainder of this example assumes that “Measures” is selected within the top level information display type selector section 704.

Below the top level information display type selector is a domain selector section 706 that enables selection of a domain, such as Surgery Leadership, ED Operations, Medical Leadership, Financial, and the like. Selecting among domains changes the list of measures available to be viewed since each domain has its own list of KPIs (measures) that are configured in a relationship with the domain. Measures for each domain are displayed in the measures selection section 710. How measures get configured in a relationship with a domain is described elsewhere herein. Measures selection section 710 is also described below. Selecting a domain also impacts a default/fixed set of filters applied (could be zero) to the data because each domain has its own list of default/fixed sets of filters. The default/fixed set of filters can be presented by selecting the default/fixed filter icon in the filter selector section 708. Within the filter selector section 708, for a given domain (e.g., medical leadership) optional filters may be configured and selected. In this example for the medical leadership domain, optional filters presented in the filter selector section 708 include patient age at admissions that includes 117 different values (e.g., patient age) and at least service line that includes 17 different values.

In example embodiments, the measures selector section 710 lists measures that have been configured in a relationship with the domain selected in domain selector section 706. In example embodiments, each domain may be defined at least in part by measures with which it is configured into a relationship. Selecting a measure within the measures selector section 710 of the display changes the results portion 714 of the screen to present results for the measure selected in the measures selector section 710. In example embodiments, switching from Acute Admissions measure to Acute Discharge Days measure changes the results portion 714 from displaying admissions related results to discharge days related results.

In example embodiments, the results type display selector portion 712 enables reconfiguring what is presented in the results portion 714. This includes, in this example, changing what is presented in the results portion 714 among: Numbers, Trends, Definitions, Governance, and Assisted Analytics results.

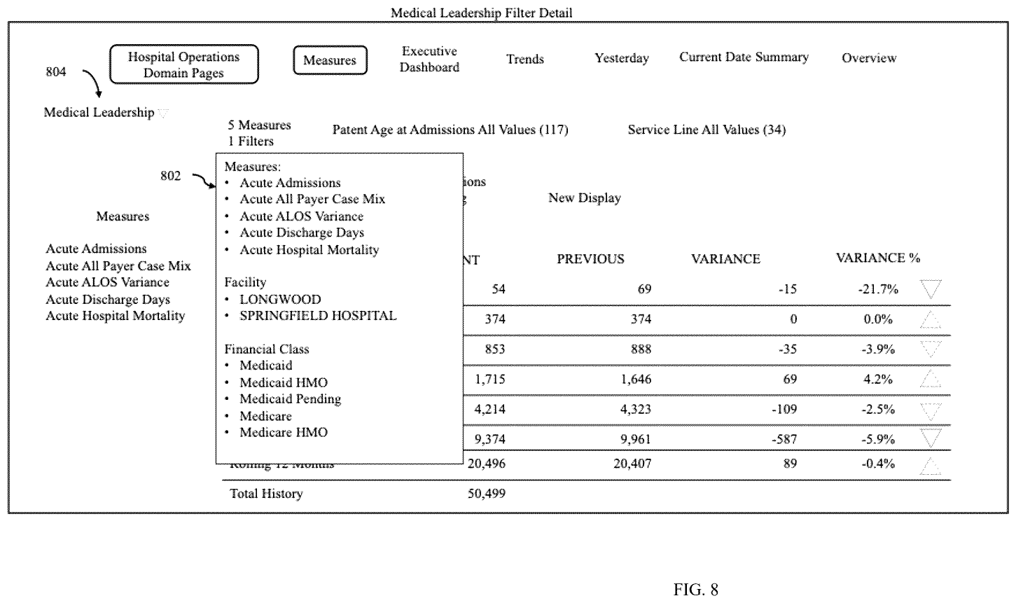

Referring to FIG. 8, a graphical user interface substantially similar to the embodiments of FIG. 7 is depicted with a further detail of measure and filter options 802 for a medical leadership domain 804.

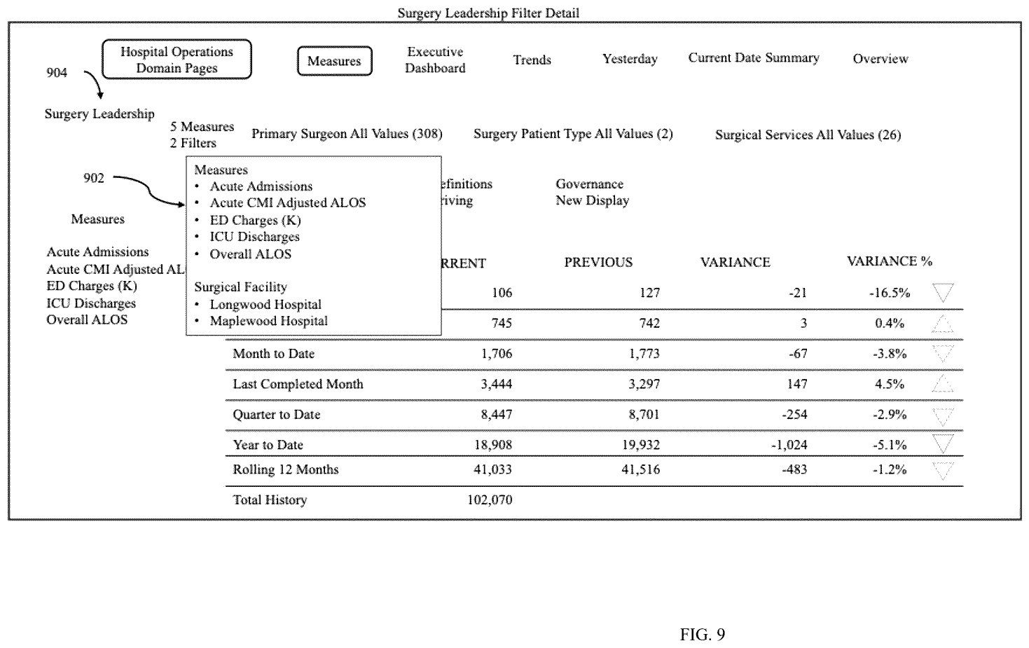

Referring to FIG. 9 a graphical user interface substantially similar to the embodiments of FIG. 8 is depicted with detail of measure and filter options 902 for a surgery leadership domain 904.

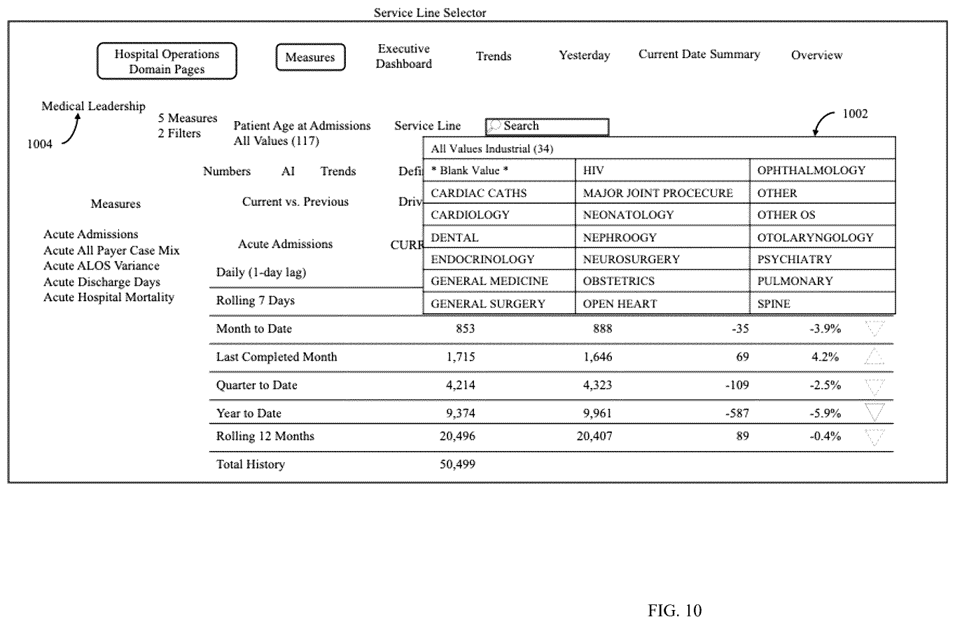

Referring to FIG. 10 a graphical user interface substantially similar to the embodiments of FIG. 7 is depicted with further detail of a service line selector 1002 for a medical leadership domain 1004.

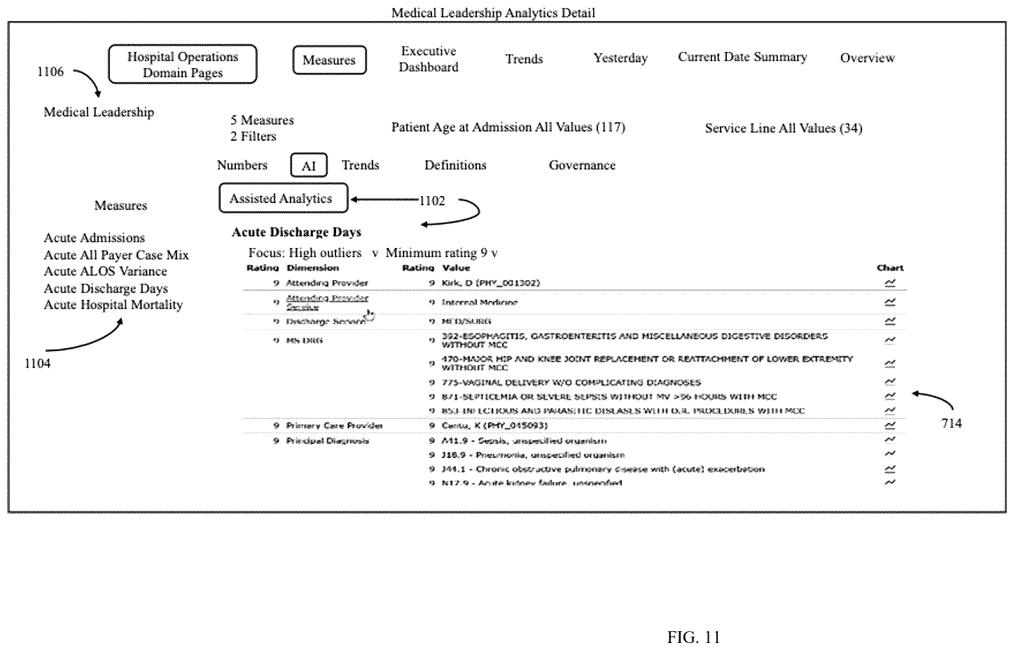

Referring to FIG. 11 a graphical user interface substantially similar to the embodiments of FIG. 7 is depicted with assisted analytics content selected 1102 and presented in the results portion 714 for an acute discharge days measure 1104 for a medical leadership domain 1106.

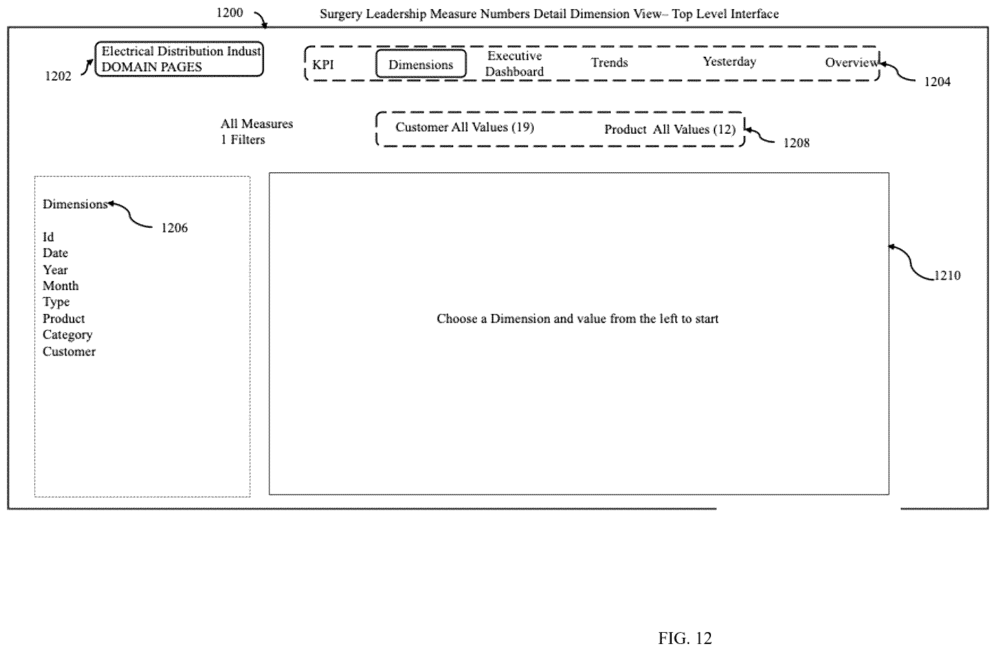

Referring to FIG. 12 a graphical user interface is depicted for a top level interface of a dimension view embodiment. In the example of FIG. 12, the user interface 1200 includes a perspective selector 1202, a view selector 1204 with “Dimensions” selected, a dimension selector 1206, a filter configurator 1208 and a results region 1210.

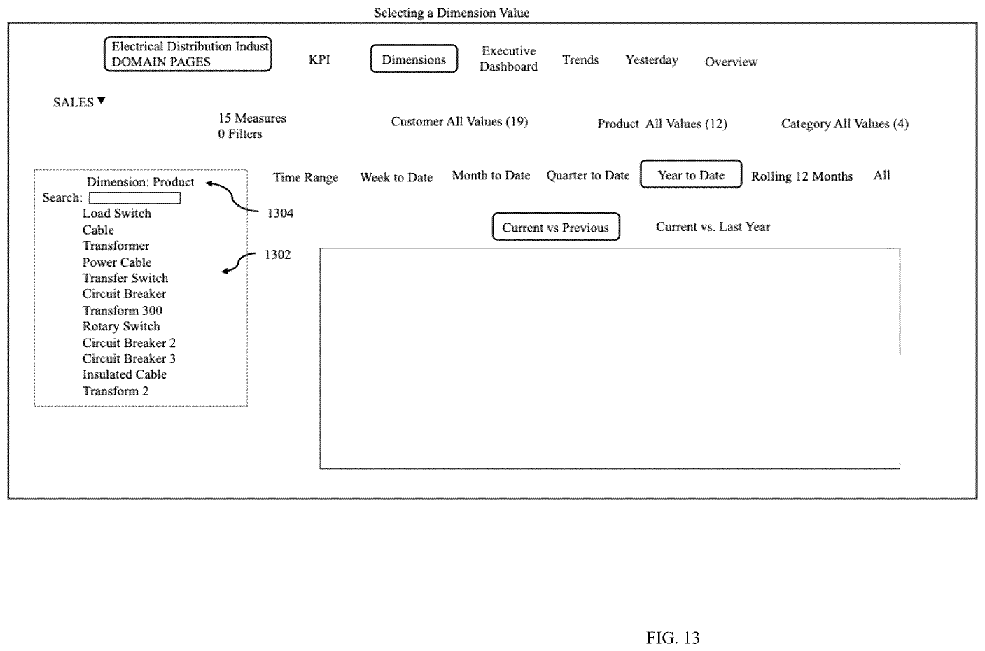

Referring to FIG. 13 a graphical user interface is depicted substantially similar to the embodiments of FIG. 12 further depicting a dimension value selector 1302 for a product dimension 1304.

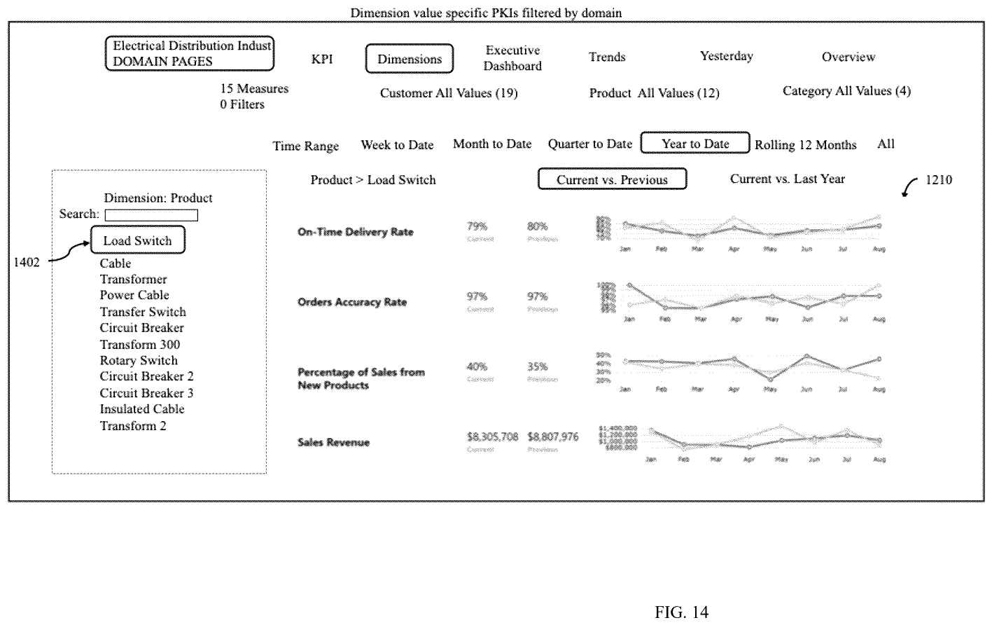

Referring to FIG. 14 a graphical user interface is depicted substantially similar to the embodiments of FIG. 13 with KPIs presented in the results region 1210 for a specific dimension value selected 1402.

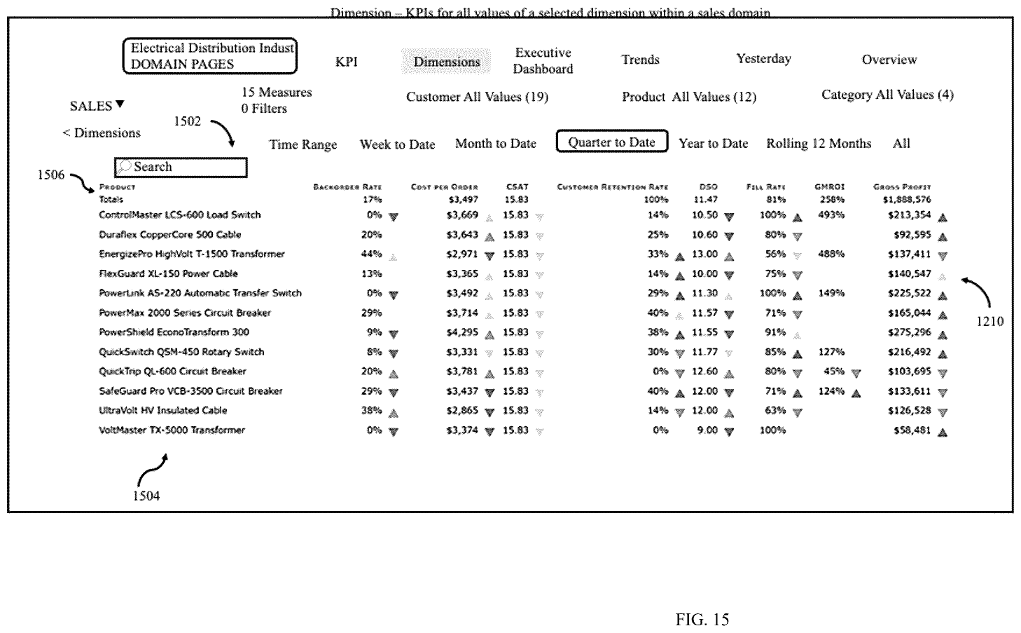

Referring to FIG. 15 a graphical user interface is depicted substantially similar to the embodiments of FIG. 13 with a tabular listing 1502 of KPIs for each dimension value 1504 in a selected dimension 1506 of “product” presented in the results region 1210.

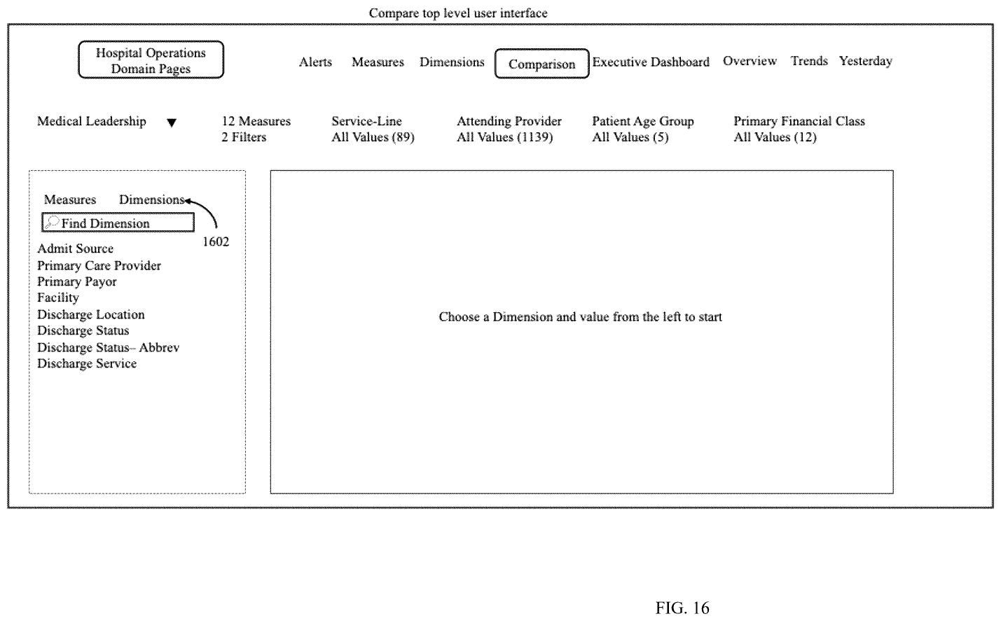

Referring to FIG. 16 a graphical user interface is depicted substantially similar to the embodiments of FIG. 7 further including a dimension selector 1602 for performing comparisons among dimensions, dimension values, groups, domains, KPIs and the like.

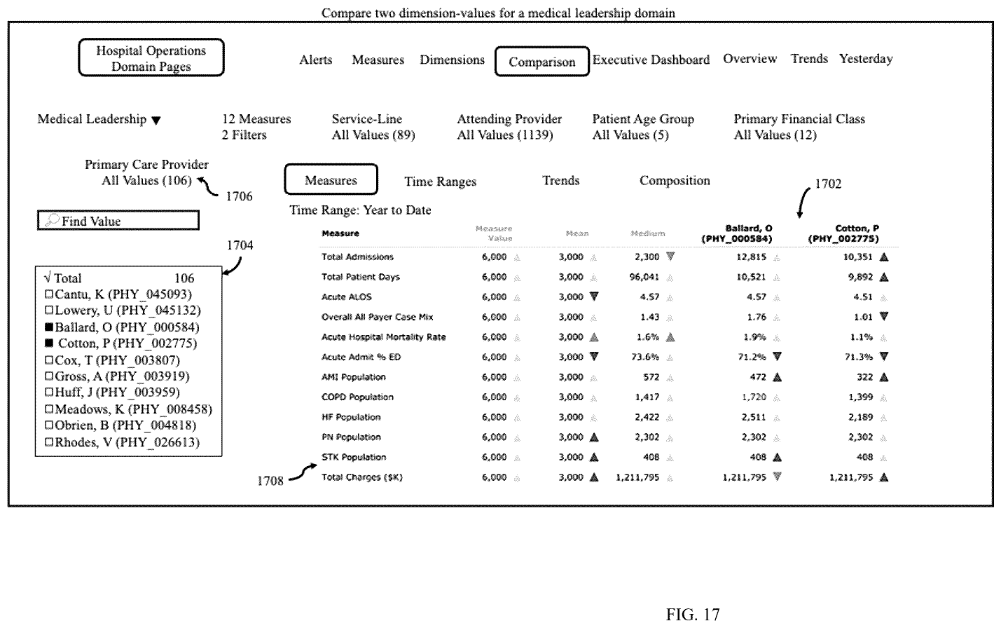

Referring to FIG. 17 a graphical user interface is depicted substantially similar to the embodiments of FIG. 16 further depicting a comparison 1702 of two dimension values 1704 for a primary care provider dimension 1706 for a plurality of measures 1708.

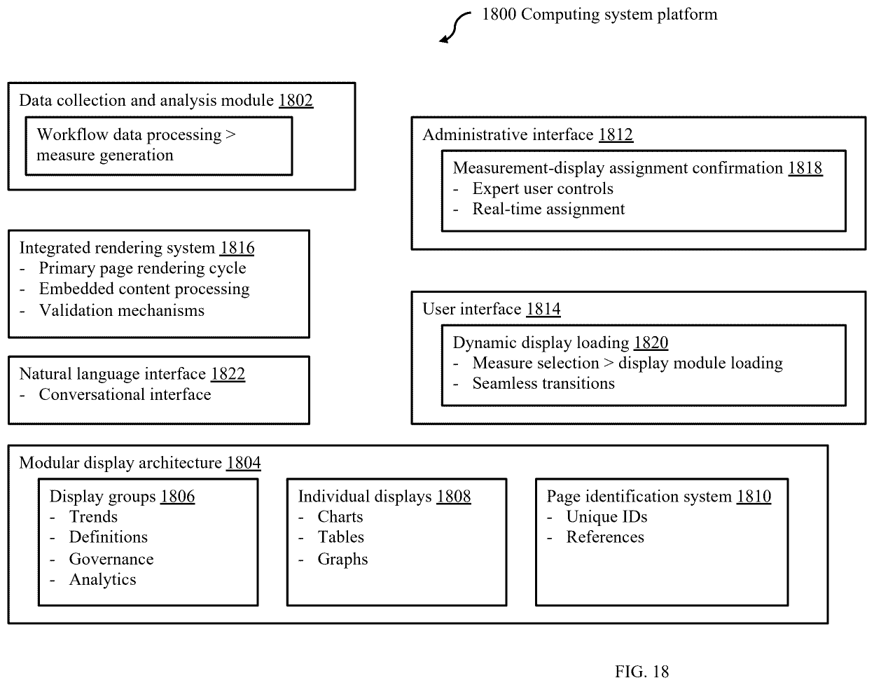

Referring to FIG. 18, a modular display architecture system 1800 may comprise a computing system platform having multiple interconnected components for dynamic measure visualization. The system 1800 may include a data collection and analysis module 1802 that processes workflow data and generates measures from business entity activities.

The modular display architecture 1804 may comprise display groups 1806, individual displays 1808, and a page identification system 1810. The display groups 1806 may include organizational categories such as trends, definitions, governance, and assisted analytics visualization types. The individual displays 1808 may comprise various visualization components including charts, tables, and graphs that can be dynamically assigned to measures. The page identification system 1810 may utilize unique identifiers and references to manage display module associations.

An administrative interface 1812 may provide measure-display assignment configuration capabilities 1818, enabling expert users to configure associations between measures and display groups through real-time assignment controls. The administrative interface 1812 may allow for removal and reassignment of displays to measures through graphical user interface controls.

A user interface 1814 may implement dynamic display loading functionality 1820, wherein measure selection triggers appropriate display module loading with seamless transitions between different visualization types. The user interface 1814 may pre-load associated display components based on user navigation patterns to enhance performance.

An integrated rendering system 1816 may process embedded content as part of a primary page rendering cycle, incorporating validation mechanisms that operate during data factory construction to ensure data integrity before presentation to users.

The system may provide a natural language interface 1822 that accepts user queries in conversational form. The interface may map the natural language queries to domains, measures, and filters by leveraging learned organizational structures and workflows from the adaptive intelligence module 106.

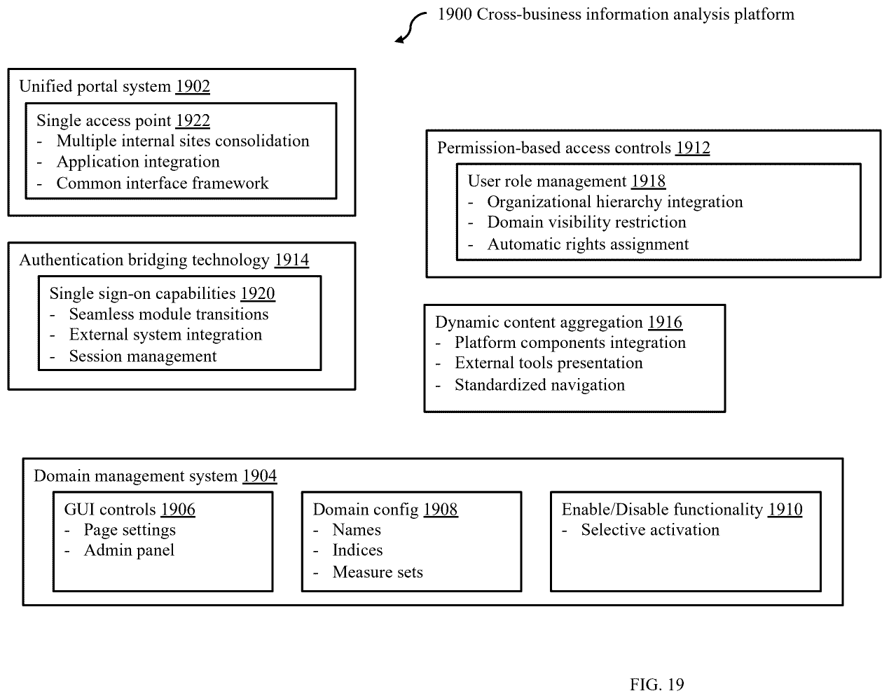

Referring to FIG. 19, an integrated portal system 1900 may comprise a cross-business information analysis platform having unified access and domain management capabilities. The system 1900 may include a unified portal system 1902 that consolidates multiple internal sites and applications into a single access point 1922 with a common interface framework.

A domain management system 1904 may comprise GUI controls 1906, domain configuration components 1908, and enable/disable functionality 1910. The GUI controls 1906 may include page settings and administrative panel interfaces. The domain configuration components 1908 may manage domain names, organizational indices, and measure set associations. The enable/disable functionality 1910 may provide selective activation capabilities for domains based on operational requirements.

Permission-based access controls 1912 may implement user role management 1918 with organizational hierarchy integration, domain visibility restriction, and automatic rights assignment capabilities. The access controls 1912 may restrict domain visibility based on user roles and present different available domains to users based on assigned permissions.

Authentication bridging technology 1914 may provide single sign-on capabilities 1920 with seamless module transitions, external system integration, and session management. The authentication bridging technology 1914 may eliminate the need for users to re-enter authentication credentials when accessing different platform components.

Dynamic content aggregation 1916 may integrate platform components, present external tools, and provide standardized navigation across the unified portal system 1902. The dynamic content aggregation 1916 may support addition of new integrated tools without requiring modifications to the core portal framework.

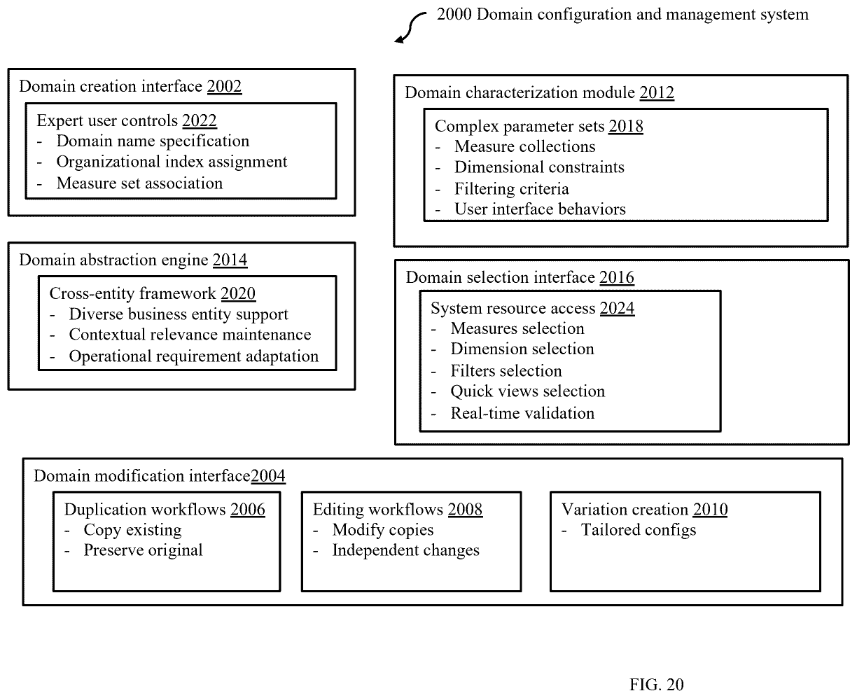

Referring to FIG. 20, an enhanced domain configuration and management system 2000 may comprise specialized interfaces and modules for comprehensive domain administration. The system 2000 may include a domain creation interface 2002 with expert user controls 2022 for domain name specification, organizational index assignment, and measure set association.

A domain modification interface 2004 may comprise duplication workflows 2006, editing workflows 2008, and variation creation capabilities 2010. The duplication workflows 2006 may copy existing domains while preserving original configurations. The editing workflows 2008 may modify copied domains with independent changes. The variation creation capabilities 2010 may generate tailored configurations for specific organizational needs.

A domain characterization module 2012 may implement complex parameter sets 2018 that define measure collections, dimensional constraints, filtering criteria, and user interface behaviors. The domain characterization module 2012 may treat domains as abstract organizational constructs applicable across different data types and business contexts.

A domain abstraction engine 2014 may enable cross-entity framework 2020 utilization with diverse business entity support, contextual relevance maintenance, and operational requirement adaptation. The domain abstraction engine 2014 may maintain the same domain framework across different business entities while preserving contextual relevance to specific operational requirements.

A domain selection interface 2016 may provide system resource access 2024 including measures selection, dimensions selection, filters selection, and quick views selection capabilities. The domain selection interface 2016 may incorporate real-time validation to prevent creation of incompatible domain parameter sets during configuration.

In example embodiments, the adaptive intelligence module 106 may map a measure to a visualization category by selecting a visualization type appropriate to properties of the measure and to an intended analytical purpose. Such mapping may be performed by rule-based logic, machine-learned models executing within the adaptive intelligence module 106, or expert configuration via an administrative interface 1812. For instance, a measure representing monthly revenue over time may be mapped to a trends category within the modular display architecture 1804 and rendered by an individual display 1808 as a line chart; a measure representing regulatory compliance status may be mapped to a governance category and rendered by an individual display 1808 as a compliance heatmap; and a measure representing the definition or calculation logic for “average length of stay” may be mapped to a definitions category and displayed as explanatory content.

A measure may exhibit a plurality of characteristics that guide presentation, grouping, and relevance determination by the measure relevance learning module 114 (and, in some embodiments, 210). Characteristics may include a data type characteristic (e.g., numeric, categorical, text), a dimensional characteristic (e.g., time-based, geography-based, role-based), an analytical characteristic (e.g., performance metric, compliance metric, financial metric), and a granularity characteristic (e.g., atomic daily entries versus aggregated quarterly totals). By way of example, a daily patient admission count may be treated as a numeric, time-based performance measure at an atomic level, whereas quarterly financial totals may be treated as aggregated financial measures pertinent to a finance domain generated or recommended by domain-set recommendation module 212.

The system associates each measure with a page identifier using the page identification system 1810. A page identifier is a unique code or reference that identifies an individual display 1808 within the modular display architecture 1804, enabling consistent reuse of visualization components across domains. Page identifiers may be alphanumeric strings, database keys, or structured resource locators. For example, a measure labeled “Acute Admissions Count” may be associated with page identifier “TREND-001,” which references a trend chart display module; a measure “Patient Satisfaction Index” may be associated with page identifier “GOV-002,” which references a governance compliance panel; and “Average Revenue per Procedure” may be associated with page identifier “FIN-015,” which references a bar-chart module.

The adaptive intelligence module 106 may apply weighted usage of measures to determine relevance for inclusion in domains and groups learned by the organizational structure learning module 110 (and/or 206) and the workflow relationship learning module 112 (and/or 208). In one example, the measure relevance learning module 114 (and/or 210) computes a composite relevance score by applying role-based and frequency-based weights to observed accesses and interactions. For example, access to a readmission rate measure by an executive role may be weighted more heavily than access by a junior analyst role, and a measure accessed one hundred times in a week may receive a higher relevance score than a measure accessed once.

The user interface 104 (and, in implementations of the modular display architecture system 1800, the user interface 1814) may dynamically load visualization modules according to assignments produced by the adaptive intelligence module 106. Dynamic loading may be implemented by the integrated rendering system 1816 and dynamic display loading functionality 1820, which instantiate the appropriate individual displays 1808 at runtime based on current mappings between measures, display groups 1806, and page identifiers managed by the page identification system 1810. For example, when a user selects a surgery leadership domain, charts and tables assigned to measures of that domain are dynamically loaded; if a KPI is reassigned from a finance domain to an operations domain, the corresponding individual display 1808 is reloaded in the operations dashboard without manual reconfiguration.

A feedback loop may be employed, in which user interaction data collected by the user interface 104/1514 is processed as feedback signals by the feedback development module 116 and supplied to the adaptive intelligence module 106 for relearning and refinement. Feedback signals may include explicit selections (e.g., filter applications), implicit behaviors (e.g., repeatedly ignoring a recommended measure), and dwell times recorded for a particular visualization. For example, repeated selection of a “Patient Age at Admission” filter may elevate that filter's prominence within a domain, whereas repeated non-selection of a suggested KPI may diminish its prominence in subsequent iterations.

User interaction data may include logs of KPI selections, filter configurations, ignored measures, and dwell times captured by the user interface 104/1514. These data are ingested by the data collection and analysis module 102 (and/or 1802) and analyzed by the learning modules 110, 112, 114 (and/or 206, 208, 210) under control of the adaptive intelligence module 106 to adjust relevance scores, refine domain composition, and revise visualization assignments maintained in the modular display architecture 1804.

Dashboards may be dynamically assembled in real time based on current mappings of measures to visualization categories within display groups 1806 and to individual displays 1808 referenced by page identifiers of the page identification system 1810. The user interface 104/1514, in cooperation with the integrated rendering system 1816, composes layouts and content responsive to outputs of the adaptive intelligence module 106. For example, a medical leadership dashboard may present mortality rate trends and compliance heatmaps as those measures gain relevance; a finance dashboard may shift from bar charts to line charts when revenue KPIs are mapped to the trends category.

The adaptive intelligence module 106 may perform iterative refinement of domain composition and visualization assignments, in which outputs of the organizational structure learning module 110/206, workflow relationship learning module 112/208, and measure relevance learning module 114/210 are re-evaluated on a periodic or event-driven basis. Each iteration may incorporate updated user interaction data from the feedback development module 116 and generate new candidate domains via domain-set recommendation module 212 or revised visualization mappings in the modular display architecture 1804. For example, weekly recalculation may update a domain's KPI set based on the prior week's usage patterns, or refinement may occur immediately upon introduction of a new workflow into the organization.

The adaptive intelligence module 106 may determine that a threshold level of relevance has been reached for one or more measures. A threshold level of relevance may be a predefined constant, a dynamically adjusted boundary, or a learned parameter indicating inclusion or elevation of a measure within a domain generated or finalized using domain-set recommendation module 212. By way of example, a threshold level of relevance may be met when a measure is accessed by more than forty percent of users in a role category, when a normalized relevance score computed by the measure relevance learning module 114/210 exceeds 0.75, or when a KPI is referenced in more than three distinct workflows across different departments.

The adaptive intelligence module 106 may also apply a deactivation threshold to determine when a domain or group should be retired, suppressed, or hidden from presentation by the user interface 104/1514. A deactivation threshold may be time-based (e.g., no access events for sixty consecutive days), usage-based (e.g., fewer than five percent of relevant roles engage with measures of the domain during a given period), or contextual (e.g., an organizational restructuring eliminates the underlying workflow). When a deactivation threshold is met, the adaptive intelligence module 106 may deactivate or retire the domain automatically or request confirmation via administrative interface 1812.

Page identifiers managed by the page identification system 1810 facilitate consistent reuse of individual displays 1808 across different domains and contexts. For example, page identifier “T-102” may reference a line-chart module for trends; page identifier “D-210” may reference a definitions card; and page identifier “G-305” may reference a governance compliance heatmap. By associating measures with page identifiers, the adaptive intelligence module 106 causes the modular display architecture 1804 to instantiate the corresponding visualization modules regardless of which domain presently includes the measure.

Pre-loading of visualization modules may be performed by the dynamic display loading functionality 1820 in cooperation with the integrated rendering system 1816 to improve perceived responsiveness. Pre-loading may include caching display content, instantiating rendering templates of individual displays 1808, and loading partial data sets predicted by the adaptive intelligence module 106 to be relevant to a next user action. For example, if a hospital administrator frequently drills into time-based KPIs, the system may pre-load a “Length of Stay” trend chart before the drill operation completes.

Visualization categories may correspond to display groups 1806 within the modular display architecture 1804, including trends, definitions, governance, and assisted analytics, as well as additional categories defined for organizational needs. For instance, trends may include time-series visualizations of monthly admissions, definitions may include modules showing KPI calculation logic, governance may include audit compliance panels, and assisted analytics may include AI-suggested correlations or predictive insights produced under control of the adaptive intelligence module 106.

A user interface engine may be implemented by the cooperative operation of the user interface 1814, integrated rendering system 1816, and dynamic display loading functionality 1820 to assemble dashboards for presentation on an electronic display. This engine interprets assignments of page identifiers from the page identification system 1810, visualization categories within display groups 1806, and measure relevance outputs of the measure relevance learning module 114/210 to dynamically generate dashboards including appropriate individual displays 1808. For example, the engine renders a medical leadership dashboard with governance and trend modules or updates a sales performance dashboard with a newly created domain produced by the domain-set recommendation module 212 and learned by the organizational structure learning module 110/206 and workflow relationship learning module 112/208.

Embodiments integrate the feedback development module 116 as depicted in FIG. 6 to capture user interactions as feedback signals and to drive relearning and refinement cycles within the adaptive intelligence module 106. The resulting outputs guide mappings within the modular display architecture 1804, including selection of display groups 1806, association of measures to page identifiers managed by the page identification system 1810, and instantiation of individual displays 1808 by the user interface 1814 and integrated rendering system 1816, as shown in FIGS. 2-4.

groups of measures may be created based on similarity of underlying data attributes. Similarity may be determined according to measure metadata, calculation logic, dimensional scope, or statistical correlation. For example, measures that are all time-series metrics such as monthly revenue, quarterly profit, and weekly sales volume may be grouped together; measures that share the same underlying dataset such as patient admissions and discharges may be grouped as a set.

Groups may also be employed for cross-domain analysis, in which measures that share common data attributes are analyzed together regardless of their role-based or workflow-based domain membership. For example, a cross-domain group of “mortality rate” may include measures relevant to surgery, medical leadership, and population health domains simultaneously, enabling comparisons across organizational contexts.

A usage threshold may be applied to weighted measure usage scores to determine inclusion of measures in candidate domains. A usage threshold may be defined as a minimum frequency of access, a minimum weighted relevance score, or a minimum proportion of users accessing the measure. For example, a threshold may require that at least 25 percent of users in a category access the measure in a given time period, or that the weighted relevance score exceed a normalized value of 0.6.

The system may apply clustering of measures when multiple measures exceed a usage threshold. Clustering may involve algorithmic grouping of measures using similarity metrics such as correlation, co-occurrence within workflows, or shared dimensionality. For example, measures that consistently rise and fall together across data entries may be clustered, or measures tied to the same workflow events may be clustered.

Domains may be finalized using both fixed filters and dynamic filters. A fixed filter may be a condition permanently associated with the domain, such as restricting a “Surgery Leadership” domain to a specific hospital service line. A dynamic filter may be a condition selectable by an individual user at runtime, such as allowing filtering of the same domain by provider name or by patient demographic.

The system may further support domain duplication workflows, wherein a user may copy an existing domain configuration while preserving its original parameters. An editing workflow may then be applied to the duplicated domain to allow modification of measures, filters, or visualization settings without affecting the original domain. For example, a “Cardiology Leadership” domain may be duplicated and then edited into a “Pediatric Cardiology Leadership” variant.

A variation creation workflow may be supported, in which a tailored domain configuration is generated based on operational requirements. For example, a domain configured for a hospital setting may be varied into a version suitable for a regional healthcare network by automatically adapting dimensional constraints and visualization categories.

A domain abstraction engine 2014 may be provided to allow the same underlying domain framework to be applied across multiple business entities while preserving contextual relevance. For example, the abstraction engine may adapt a “Finance” domain configured for a healthcare system to a manufacturing entity by replacing measures specific to patient encounters with measures specific to product units, while maintaining governance and trend visualization categories.

The system may provide a natural language interface 1822 that accepts user queries in conversational form. The interface may map the natural language queries to domains, measures, and filters by leveraging learned organizational structures and workflows from the adaptive intelligence module 106. For example, a query “show me admissions by service line last quarter” may be mapped to a workflow and dimension selection, while “compare revenue for east and west regions” may be mapped to domain measures for finance.

The natural language interface may generate analytical workflow recommendations based on historical user interactions. For example, if users frequently compare length of stay with readmission rate, the system may recommend an analytical workflow displaying both measures together.

Conversational navigation may be supported, allowing users to move between domains, dashboards, and visualization modules using natural language commands. For example, a user may say “switch to surgery leadership view” to change dashboards, or “filter by provider A” to apply a filter without using menu-based selection.

The system may further provide explanatory responses in natural language that describe measures, their definitions, and relationships to organizational structures. For example, in response to a query “what is average length of stay?” the system may present a definition visualization module along with a description of how the measure relates to patient admission and discharge workflows.

### Inventive Statements

A system for adaptive presentation of business measures may have a data flow architecture that may include at least an input interface, a processing subsystem, and an output interface. The input interface receiving workflow data describing activities of a business entity, organizational hierarchy data identifying categories of employee roles, and user interaction data representing measure selections, filters, or dwell times. The processing subsystem comprising a structure learner that derives relationships among the categories of employee roles, a workflow mapper that associates workflows with portions of the organizational hierarchy, a relevance analyzer that determines relevance of measures to portions of the organizational hierarchy based on weighted usage of the measures, and an adaptive intelligence engine that generates candidate domains of measures, reconfigures the domains in response to the user interaction data, and assigns the measures to visualization groups and page-identified modules of a modular display architecture. The output interface presenting, on a display device, dashboards dynamically loaded with visualization modules according to assignments of the adaptive intelligence engine.

In example embodiments, the relevance analyzer applies hierarchical weighting so that access to measures by higher-level roles is weighted more heavily than access by lower-level roles. In example embodiments, the adaptive intelligence engine creates a new domain when a threshold of relevance is detected for a plurality of measures and retires a domain when usage of its measures falls below a deactivation threshold. In example embodiments, the adaptive intelligence engine maps measures to visualization categories such as trends, definitions, governance, or assisted analytics, and associates each measure with a page identifier referencing a specific display module of the modular display architecture. In example embodiments, the adaptive intelligence engine retrains the structure learner, workflow mapper, or relevance analyzer when a retraining threshold is reached, the retraining threshold including a time-based interval or a usage-based accumulation of user interaction data. In example embodiments, the user interaction data includes explicit filter selections, ignored measures, and dwell times recorded by the input interface. In example embodiments, the output interface pre-loads visualization modules to provide seamless transitions between dashboards. In example embodiments, the adaptive intelligence engine iteratively refines domain composition and visualization assignments using a feedback loop that processes the user interaction data.

A system may include a combination of modules and processors executing a data flow architecture. The system may be configured for adaptive presentation of business measures and may comprise at least one processor, a memory, an input interface, a processing subsystem, and an output interface. The input interface receiving workflow data of a business entity, organizational hierarchy data identifying categories of employee roles, and user interaction data representing selections, filters, or dwell times. The processing subsystem operable by the processor comprising an organizational structure learner that derives relationships among the categories of employee roles, a workflow mapper that associates workflows with portions of the organizational hierarchy, a relevance analyzer that determines relevance of measures to portions of the organizational hierarchy based on weighted usage of the measures, and an adaptive intelligence module 106 that generates domains of measures based on the derived relationships and relevance, reconfigures the domains in response to the user interaction data, and assigns measures to visualization modules by mapping each measure to a visualization group and associating the measure with a unique page identifier of the page identification system within a modular display architecture. The output interface presenting, on an electronic display, dashboards in which visualization modules are dynamically loaded according to assignments of the adaptive intelligence module.

In example embodiments, the relevance analyzer applies role-based weighting so that access to measures by senior roles is given greater weight than access by junior roles. In example embodiments, the adaptive intelligence module automatically generates a new domain when relevance of a plurality of measures meets a threshold and retires a domain when usage falls below a deactivation threshold. In example embodiments, the adaptive intelligence module maps measures to visualization categories such as trends, definitions, governance, and assisted analytics, and associates each measure with a page identifier that references an individual display of the modular display architecture. In example embodiments, the adaptive intelligence module retrains the organizational structure learner, the workflow mapper, or the measure relevance learning module when a retraining threshold is satisfied, including a time-based threshold or a usage-based threshold. In example embodiments, the user interaction data includes feedback signals comprising filter applications, ignored measures, or dwell times, which are processed by the feedback development module. In example embodiments, the output interface pre-loads visualization modules predicted by the adaptive intelligence module to ensure seamless transitions between dashboards. In example embodiments, the adaptive intelligence module iteratively refines domains and visualization assignments in response to feedback. In example embodiments, the page identification system supports reuse of display modules across different measures while maintaining measure-specific customization.

A dimension-centric outlier detection & remediation system for analyzing business performance measures comprising a set of dimensions that characterize business data entries, a dimension selection facility for associating data entries with dimensions, a primary dimension determination facility for identifying a primary dimension of a data entry, and a KPI detection facility for identifying key performance indicators impacted by the primary dimension. The system further comprising an outlier detection facility for detecting outliers in the identified KPIs, an outlier source detection facility for determining whether a dimension value contributes to two or more outliers across distinct KPIs, and a remedial action facility for initiating remedial actions in response to the identified outlier source.

In example embodiments, the outlier detection facility identifies outliers by trending KPI values over time. In example embodiments, the outlier source detection facility compares KPI results with and without a dimension value to determine its contribution. In example embodiments, the remedial action facility initiates alerts, modifies workflows, or reallocates resources when a dimension value is determined to contribute to outliers. In example embodiments, the remedial action facility determines commonality of dimension values contributing to multiple KPIs. In example embodiments, dimensions may include time, geography, product, or service. In example embodiments, remedial actions may include automated updates to workflow configurations when a dimension value is repeatedly identified as a source of outliers.

A modular display architecture with page IDs for dynamic measure visualization comprising a data collection and analysis module for generating measures, a plurality of display groups each corresponding to an organizational category of visualization types, and a plurality of individual display modules assignable to measures. The modular display architecture further comprising a page identification system that assigns a unique page identifier to each display module, an administrative interface enabling assignment of measures to display groups and modules, and a user interface for dynamically loading display modules according to the assigned identifiers.

In example embodiments, display groups include trends, definitions, governance, and assisted analytics. In example embodiments, the page identification system enables reuse of visualization components across multiple measures while preserving customization. In example embodiments, the administrative interface enables real-time reassignment of display modules to measures without system-wide changes. In example embodiments, the user interface pre-loads display modules to provide seamless transitions. In example embodiments, the integrated rendering system processes embedded content within a primary rendering cycle to improve performance. In example embodiments, validation mechanisms operate to ensure integrity of the data displayed by the visualization modules.

A cross-business information analysis platform comprising a unified portal system with authentication bridging that consolidates multiple internal sites and applications into a single access point, a domain management system comprising configuration components for defining domain names, indices, and measure sets, and permission-based access controls that restrict domain visibility according to user roles and organizational hierarchy. The platform further comprising authentication bridging technology providing single sign-on across modules and external systems, and a dynamic content aggregation system integrating platform components and external tools into a common interface framework.

In example embodiments, the unified portal system consolidates application access into a consistent interface framework. In example embodiments, the domain management system supports creation, duplication, and modification of domains tailored to organizational needs. In example embodiments, permission-based access controls automatically assign access rights in conjunction with learned organizational structures. In example embodiments, the authentication bridging technology eliminates repeated entry of credentials during navigation and maintains user sessions across modules. In example embodiments, dynamic content aggregation enables addition of new external tools without modification of the core framework. In example embodiments, domains may be selectively enabled or disabled based on operational requirements, and users presented with different domain views according to assigned permissions.

A system for weighted measure usage and domain-set recommendation wherein a usage threshold is applied to determine inclusion of measures into candidate domains. In example embodiments, a weighted measure usage score is computed by multiplying observed access events by a weight corresponding to the category of the accessing role. In example embodiments, clustering is applied to measures that exceed the usage threshold, enabling automatic grouping of related measures into candidate domains. In example embodiments, expert users may finalize candidate domains by selecting fixed filters that permanently constrain the domain and dynamic filters that allow individual users to tailor the display of measures. In example embodiments, dynamic filters enable a single domain definition to support multiple user perspectives by adjusting dimensions in real time.

A system for domain creation and management wherein a domain creation interface enables specification of a domain name, an organizational index, and an associated measure set. In example embodiments, a duplication workflow is provided to copy an existing domain configuration while preserving original parameters. In example embodiments, an editing workflow may be applied to a duplicated domain, enabling modification of measures, filters, or visualization settings without altering the original. In example embodiments, a variation creation workflow may be used to generate tailored configurations of a domain based on operational requirements, such as adapting a hospital leadership domain to a regional network leadership domain. In example embodiments, a domain abstraction engine allows the same domain framework to be applied across multiple business entities while maintaining contextual relevance, thereby extending portability and reusability of domain logic.

A system for overlapping subset formation wherein measures are grouped into groups based on similarity of underlying data attributes and into domains based on relevance to organizational roles and workflows. In example embodiments, a measure may be simultaneously included in both a group and a domain, thereby supporting multiple perspectives. In example embodiments, groups are employed for cross-domain analysis of similar KPIs regardless of organizational structure. In example embodiments, domains are employed for role-specific dashboards constrained by workflows, while groups allow analytic comparisons across organizational silos.

A system for integrated rendering of measure visualizations wherein an integrated rendering system processes embedded content as part of a primary page rendering cycle. In example embodiments, the integrated rendering system avoids reliance on iframe-based loading mechanisms, thereby improving performance and security. In example embodiments, the integrated rendering system pre-loads associated visualization modules based on predicted user navigation patterns to enable seamless transitions. In example embodiments, validation mechanisms operate during rendering to ensure the integrity of displayed measures. In example embodiments, transitions between visualization types are rendered without interruption to maintain user context.

A system for feedback-driven relearning of measure relevance wherein user feedback is derived from filter applications, ignored measures, and dwell times. In example embodiments, the feedback development module retrains the measure relevance learning module based on aggregated user feedback. In example embodiments, retraining is triggered when a measure is ignored by a threshold percentage of users in a role category. In example embodiments, retraining reduces the prominence of measures consistently ignored by users and increases the prominence of measures emphasized through repeated user selections. In example embodiments, the iterative application of feedback enables the system to adapt measure relevance to evolving organizational behaviors.

A system for AI-enhanced natural language and workflow assistance wherein a natural language interface allows users to query domains, measures, or filters conversationally. In example embodiments, the interface maps user queries to organizational structures and workflows learned by the adaptive intelligence module 106. In example embodiments, the natural language interface generates recommendations for analytical workflows based on historical user interactions. In example embodiments, conversational navigation is supported, allowing users to move between domains, dashboards, and filters through natural language commands. In example embodiments, explanatory responses are provided to clarify measure definitions and their relationships to organizational structures, thereby improving user understanding and adoption of analytic tools.

A computing system platform: having a data collection and analysis module for generating measures of activities described in a set of workflows of a business entity; having a user interface accessible through an electronic display of a computing resource of the platform, the user interface adaptably representing sets of measures responsive to one of a group selection or a domain selection and to selection of one or more of a plurality of dynamic measure display filters in the user interface; and having an adaptive intelligence module that learns: an organizational structure of the business entity including categories of employee roles; relationships between the workflows and portions of the organization structure; and relevance of generated measures to portions of the organizational structure based on use of the generated measures by a plurality of the categories of employee roles; the adaptive intelligence module further generates at least one of: sets of measures as a group of similar measures based on at least one of a degree of similarity of data contributing to each measure or a dimension of the contributing data that is common across a plurality of types of the contributing data, or sets of measures as domains that are based on the learned relationships, learned relevance, and learned organizational structure; wherein the learnings of the adaptive intelligence module are adjusted through relearning based on feedback developed from observing user interaction with the platform through the user interface.

A platform for assisting in structuring a plurality of measures into overlapping subsets targeting operational portions of a business entity, the platform: having an organizational structure learning module that learns an organizational structure of the business entity including categories of employee roles; having a workflow relationship learning module that learns relationships between the workflows and portions of the organization structure; having measure relevance learning module that learns relevance of generated measures to portions of the organizational structure based on use of the generated measures by a plurality of the categories of employee roles; generating candidate groups of sets of the measures based on at least one of a degree of similarity of data contributing to each measure or a dimension of the contributing data that is common across a plurality of types of the contributing data; generating candidate domains of sets of the measures based on the learned relationships, learned relevance, and learned organizational structure; having a feedback development module that forms feedback for the platform by analyzing observed user interaction with the platform through the user interface; and retraining at least one of the organizational structure learning module, the workflow relationship learning module, or the measure relevance learning module based on the feedback formed from the analyzed user interactions.

A platform for determining relationships among measures of business activities described in workflows of a business entity and portions of an organizational structure of the business entity, the platform: having an organizational structure learning module that learns an organizational structure of the business entity including categories of employee roles; having a workflow relationship learning module that learns relationships between the workflows and portions of the organization structure; having a measure relevance learning module that learns relevance of generated measures to portions of the organizational structure based on use of the generated measures by a plurality of the categories of employee roles, comprising: identifying use of measures by a plurality of portions of the organizational structure based on observing access to the measures by employees associated with each of the plurality of portions of the organizational structure; weighting the use of the measures based on a category of a role of each employee accessing each of the measures; and calculating a degree of measure usage by each of the plurality of portions of the organizational structure for each measure by computing the observed access with the weighting; and having a domain-set recommendation module that determines a degree of usage measure threshold for at least one of the plurality of portions of the organizational structure, above which corresponding measures are identified as candidate measures for inclusion in a domain measure-set, wherein the domain measure-set is accessible to a portion of the employees of the at least one of the plurality of portions of the organizational structure in a domain-specific dynamically rendered dashboard in an electronic user interface.

And wherein a user (expert) finalized the domain measure-set by selecting a fixed set of measures among the candidate measures, a fixed set of filters for the domain measure-set and at least one user-selectable dynamic filter.

A platform for relating a dimension value to a set of business performance measures, the platform comprising: a set of dimensions that characterize business data entries used to calculated business performance measures, wherein each data entry characterized by a dimension represents a value of the dimension (a “dimension value”); a dimension selection facility that receives a business data entry and produces one or more dimension identifiers based on the set of dimensions; a primary dimension determination facility that determines a primary dimension for the business data entry based on utilization of the business data entry as a dimension value for the primary dimension; a KPI detection facility that determines one or more KPIs that are impacted by the primary dimension, based on a [description of] [business rule for] calculating the one or more KPIs; an outlier detection facility that identifies outliers in at least a subset of the one or more KPIs, based on trending of the subset; an outlier source detection facility that determines if the dimension value contributes to one or more of the outliers by at least one of: (i) generating a KPI for each of the one or more outliers with and without the dimension value and comparing results; or (ii) looking for commonality of the dimension value contributing to two or more of the outliers for distinct KPIs; and a remedial action selection and initiation facility for remedial action based on an outlier source that contributes to the two or more outliers for distinct KPIs. And wherein commonality of a dimension value for different KPIs can be helpful in determining remedial actions (a specific doctor/product impacting different aspects of a business operation/workflow)

A modular display architecture having computing system platform for dynamic measure visualization comprising. The computing system platform for dynamic measure visualization having one or more of: a data collection and analysis module for generating measures of activities described in workflows of a business entity. The computing system platform for dynamic measure visualization further having a modular display architecture comprising display groups and individual displays that can be dynamically assigned to measures, wherein each display group represents an organizational category of visualization types. The computing system platform for dynamic measure visualization further having a page identification system whereby each display module is referenced by a unique page identifier that corresponds to a specific visualization implementation. The computing system platform for dynamic measure visualization further having an administrative interface for configuring associations between measures and display groups, enabling expert users to assign specific display modules to measures based on analysis requirements. The computing system platform for dynamic measure visualization further having a user interface that dynamically loads appropriate display modules based on configured associations between selected measures and assigned display groups. The computing system platform for dynamic measure visualization further having an integrated rendering system that processes embedded display content as part of a primary page rendering cycle to improve transition performance between different measures and display types.

In example embodiments, the modular display architecture enables reuse of display components across different measures while maintaining measure-specific customization capabilities.

In example embodiments, the page identification system supports dynamic content loading without requiring separate iframe-based loading mechanisms.

In example embodiments, the administrative interface provides real-time configuration of display assignments without requiring system-wide changes.

In example embodiments, the integrated rendering system includes validation mechanisms that operate during data factory construction to ensure data integrity before presentation.

In example embodiments, display groups are organized into multiple organizational categories including trends, definitions, governance, and assisted analytics.

In example embodiments, the user interface provides seamless transitions between display modules by pre-loading associated display components based on user navigation patterns.

In example embodiments, the modular display architecture supports both static display assignments and dynamic display selection based on measure characteristics.

In example embodiments, the administrative interface includes functionality for removing and reassigning displays to measures through graphical user interface controls.

A modular display architecture having an integrated portal system with domain management for a cross-business information analysis platform. The cross-business information analysis platform having a unified portal system that consolidates multiple internal sites and applications into a single access point with integrated single sign-on capabilities. The cross-business information analysis platform having a domain management system with graphical user interface elements that enable domain configuration, including domain enable/disable functionality accessible through page settings. The cross-business information analysis platform having permission-based domain access controls that restrict domain visibility based on user roles and organizational hierarchy, wherein different users are presented with different available domains based on assigned permissions. The cross-business information analysis platform having domain creation and modification interfaces that enable expert users to define new domains by specifying domain names, organizational indices, and associated measure sets. The cross-business information analysis platform having dynamic content aggregation whereby various platform components and external tools are presented through a common interface framework. The cross-business information analysis platform having authentication bridging technology that enables seamless transitions between different platform modules and external integrated systems without requiring re-authentication.

In example embodiments, the domain management system supports domain duplication and modification workflows for creating variations tailored to specific organizational needs.

In example embodiments, domains are characterized as complex parameter sets that define measure collections, dimensional constraints, filtering criteria, and user interface behaviors.

In example embodiments, the permission-based access controls operate in conjunction with an organizational structure learning module to automatically assign appropriate domain access rights.

In example embodiments, the unified portal system eliminates the need for users to re-enter authentication credentials when accessing different platform components.

In example embodiments, the domain creation interfaces include selection of measures, dimensions, filters, and quick views from available system resources.

In example embodiments, the dynamic content aggregation supports addition of new integrated tools without requiring modifications to the core portal framework.

In example embodiments, domains can be selectively activated or deactivated based on operational requirements without requiring system-wide changes.

In example embodiments, the authentication bridging technology utilizes single sign-on protocols to maintain user sessions across multiple integrated applications.

An enhanced domain configuration and management system for cross-business information analysis having a domain creation interface that enables expert users to define new domains by specifying domain names, organizational indices, and associated measure sets selected from available system resources. The enhanced domain configuration and management system for cross-business information analysis having a domain modification interface that supports domain duplication and editing workflows, whereby existing domains can be copied and modified to create variations tailored to specific organizational needs. The enhanced domain configuration and management system for cross-business information analysis having a domain characterization module that treats domains as complex parameter sets defining measure collections, dimensional constraints, filtering criteria, and user interface behaviors. The enhanced domain configuration and management system for cross-business information analysis having a domain abstraction engine that enables the same domain framework to be utilized across diverse business entities while maintaining contextual relevance to specific operational requirements. The enhanced domain configuration and management system for cross-business information analysis having a domain selection interface that provides access to measures, dimensions, filters, and quick views from available system resources during domain configuration.

In example embodiments, the domain creation interface includes functionality for assigning organizational indices that determine display order and hierarchical positioning of domains within the system.

In example embodiments, the domain modification interface enables copying of existing domain configurations and subsequent editing of copied domains without affecting original domain settings.

In example embodiments, the domain characterization module abstracts domains as organizational constructs that can be applied across different data types and business contexts rather than being limited to specific data fields.

In example embodiments, the domain abstraction engine maintains contextual relevance by adapting domain parameters to specific operational requirements while preserving the underlying domain framework structure.

In example embodiments, the domain selection interface provides real-time validation of measure and dimension compatibility during domain configuration to prevent creation of incompatible domain parameter sets.

1. A computing system for adaptive presentation of business measures, comprising:
at least one processor and a memory;
an organizational structure learning module embodied in the memory and operable by the processor to learn categories of employee roles within an organizational hierarchy;
a workflow relationship learning module embodied in the memory and operable by the processor to learn associations between workflows and the categories of employee roles;
a measure relevance learning module embodied in the memory and operable by the processor to evaluate usage of measures by the categories of employee roles and to determine relevance of the measures to portions of the organizational structure;
an adaptive intelligence core operable by the processor to:
generate domains of measures based on the learned associations and relevance,
reconfigure domains based on feedback derived from observed user interactions, and
assign visualization modules to the measures by mapping the measures to display groups and unique page identifiers within a modular display architecture; and
a user interface engine operable by the processor to render, on an electronic display, domain-specific dashboards comprising the visualization modules assigned by the adaptive intelligence core.

2. The computing system of claim 1, wherein the measure relevance learning module weights access to measures based on a hierarchy of employee roles such that access by higher-level roles has greater weight than access by lower-level roles.

3. The computing system of claim 1, wherein the adaptive intelligence core automatically creates a new domain upon detecting a threshold level of relevance for a plurality of measures associated with a common workflow, and retires an existing domain when usage of measures in the domain falls below a deactivation threshold.

4. The computing system of claim 1, wherein the adaptive intelligence core maps a measure to a visualization category based on a characteristic of the measure and associates the measure with a page identifier that references a display module of the modular display architecture.

5. The computing system of claim 1, wherein the adaptive intelligence core retrains the organizational structure learning module, the workflow relationship learning module, or the measure relevance learning module upon detecting one of: (i) passage of a time-based threshold or (ii) exceeding of a usage-based threshold derived from user interactions.

6. The computing system of claim 1, wherein the feedback comprises at least one of: (i) filter selections, (ii) measure selections, (iii) measure ignore events, or (iv) dwell times on measures.

7. The computing system of claim 1, wherein the user interface engine pre-loads visualization modules identified by the adaptive intelligence core to provide seamless transitions between dashboards.

8. The computing system of claim 1, wherein the modular display architecture comprises at least one of: trends, definitions, governance, or assisted analytics visualization groups.

9. The computing system of claim 1, wherein the adaptive intelligence core integrates the feedback loop to iteratively refine domain composition and visualization assignments.

10. A method for adaptive presentation of business measures, comprising:
learning categories of employee roles within an organizational hierarchy;
learning associations between workflows and the categories of employee roles;
determining relevance of measures to portions of the organizational structure based on usage of the measures;
generating domains of measures based on the learned associations and relevance;
reconfiguring domains based on feedback derived from observed user interactions;
assigning visualization modules to the measures by mapping the measures to display groups and page identifiers within a modular display architecture; and
rendering, on an electronic display, dashboards comprising the visualization modules assigned to the measures.

11. The method of claim 10, further comprising weighting access to measures according to a hierarchy of employee roles.

12. The method of claim 10, further comprising creating a domain when a threshold level of relevance is detected for a plurality of measures associated with a workflow, and retiring a domain when usage of its measures falls below a threshold.

13. The method of claim 10, wherein assigning visualization modules comprises mapping measures to visualization categories based on characteristics of the measures.

14. The method of claim 10, further comprising retraining at least one of the organizational structure learner, workflow learner, or measure relevance learner upon detection of a time-based or usage-based retraining threshold.

15. The method of claim 10, wherein the feedback comprises user interactions including filter selections, ignored measures, or dwell times.

16. The method of claim 10, further comprising pre-loading visualization modules identified for a dashboard to provide seamless transitions between modules.

17. The method of claim 10, wherein the dashboards comprise visualization modules selected from groups including trends, definitions, governance, and assisted analytics.

18. The method of claim 10, further comprising refining domain composition and visualization assignments using an iterative feedback loop.
